(19) United States
(12) Patent Application Publication
(10) Pub. No.: US 2019/0286816 A1
(43) Pub. Date: Sep. 19, 2019

(54) BEHAVIOR RECOGNITION, DATA PROCESSING METHOD AND APPARATUS

(71) Applicant: Alibaba Group Holding Limited, Grand Cayman (KY)

(72) Inventor: Yingfang Fu, Beijing (CN)

(21) Appl. No.: 16/357,126

(22) Filed: Mar. 18, 2019

(30) Foreign Application Priority Data
Mar. 19, 2018 (CN) 201810225782.7

(51) Int. Cl. G06F 21/55; G06F 3/06; H04L 9/08; H04L 9/32

(52) U.S. Cl. CPC G06F 21/552; G06F 3/0604; G06F 3/0659; G06N 20/00; G06F 21/554; H04L 9/0897; H04L 9/3268; G06F 3/0673

(57) ABSTRACT

A behavior recognition, data processing method and apparatus are provided, the behavior recognition method including: detecting a data operation behavior; obtaining data processing features of a data processing unit with regard to the data operation behavior; and recognizing the data operation behavior based on the data processing features. The present disclosure may, based on the data processing features, recognize data operation behaviors in accordance, which is beneficial to performing governance upon the various data operation behaviors of an electronic device, preventing or blocking potentially hazardous data operation behaviors, exercising preventative measures, effectively reducing the likelihood of data loss on the electronic device or damage to the electronic device, and increasing security and reliability of data and the electronic device.

### CROSS REFERENCE TO RELATED PATENT APPLICATIONS

This application claims priority to Chinese Patent Application No. 201810225782.7, filed on Mar. 19, 2018 and entitled “BEHAVIOR RECOGNITION, DATA PROCESSING METHOD AND APPARATUS”, which is incorporated herein by reference in its entirety.

### TECHNICAL FIELD

The present invention belongs to the field of computers, and particularly relates to behavior recognition, data processing methods and apparatuses.

### BACKGROUND

With the development of computer technology, many kinds of electronic devices are becoming ever more widely used, and likewise, security problems associated with electronic devices are receiving ever wider attention. Electronic devices may be implanted with Trojans (such as ransomware) or viruses and such malicious programs, thereby resulting in data loss or device damage and such problems.

In present technology, data on an electronic device may be backed up, and upon determining that the electronic device has been implanted with a malicious program, that is, upon determining that data on the electronic device is no longer secure, data on the electronic device may be restored through the backup, thereby lowering the likelihood of loss caused for a user or electronic device. However, since the backup of data usually needs to consume large quantities of time and storage space, is easily limited by the amount of data and size of storage space on an electronic device, and at the same time data may only be restored to its state at the time of backup, limitations are extensive, it is difficult to effectively solve the problems of data loss or device damage, and security and reliability are poor.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

Given the above-mentioned problems, a behavior recognition, data processing method and apparatus provided by the present disclosure to overcome the above-mentioned problems or at least partially solve the above-mentioned problems are set forth.

According to an aspect of the present disclosure, a behavior recognition method is provided, including:

Detecting a data operation behavior;

Obtaining data processing feature of a data processing unit with regard to the data operation behavior;

Recognizing the data operation behavior based on the data processing features.

Obtaining data processing feature of a data processing unit with regard to the data operation behavior may include:

Obtaining processing attribute information of the data processing unit; and

Determining change data of processing attribute information before and after data processing, designated as data processing features of the data processing behavior.

The processing attribute information may include at least one of data attribute information, interaction status information between processing units, unit execution status information, and unit attribute information.

The data processing features may include at least one of data change information, interaction change information, execution status change information, and unit attribute change information of processing units.

Obtaining data processing feature of a data processing unit with regard to the data operation behavior may include:

Determining at least one data processing unit involved in a data processing procedure; and

Monitoring data processing features of the at least one data processing unit.

The data processing unit may include external memory, internal memory, a cache or a processor.

Recognizing the data operation behavior based on the data processing features may include:

Determining the data operation behavior as conforming to a behavior type corresponding to an attack behavior.

Determining the data operation behavior as conforming to a behavior type corresponding to an attack behavior may include:

Determining the data operation behavior as including a data write operation.

Recognizing the data operation behavior based on the data processing features may include:

Determining, based on the data processing features satisfying data processing features corresponding to data encryption operations, the data operation behavior as including a data encryption operation.

Recognizing the data operation behavior based on the data processing features may include:

Determining, based on the data processing features satisfying target data processing features corresponding to a feature operation behavior, the data operation behavior as including the feature operation behavior.

The method may further include:

Obtaining the target data processing features in at least one manner among statistical analysis, machine learning, and behavior pattern analysis.

The feature operation behavior may be an attack behavior, and the method may further include:

Blocking, if the data operation behavior is determined as including the feature operation behavior, execution of the data operation behavior.

Before blocking execution of the data operation behavior, the method may further include:

Notifying regarding the feature operation behavior, and receiving feedback information confirming that the feature operation behavior includes an attack behavior.

Obtaining data processing feature of a data processing unit with regard to the data operation behavior may include:

Obtaining, through a monitoring unit of an operating system kernel, the data processing features, the monitoring unit having monitoring authorization with regard to the data processing unit.

Detecting a data operation behavior may include:

Detecting a data operation behavior of an external device.

Before detecting a data operation behavior, the method may further include:

Receiving a user registration request of the external device, and completing a user registration flow of the external device based on a public key and a certificate of each of the current device and the external device.

The public key and private key of the current device may be saved on a built-in trusted chip.

The method may further include:

Obtaining public keys and certificates of each of the external device and the current device from a platform certification authority, utilized to complete a user registration flow of the external device.

According to another aspect of the present disclosure, a data processing method is provided, including:

Detecting a data operation behavior, and determining that the data operation behavior includes a write operation;

Determining that the write operation is a data encryption operation; and

Evaluating, based on a preset rule, execution of the data encryption operation.

Determining that the write operation is a data encryption operation may include:

Obtaining data processing features of a data processing unit with regard to the write operation; and

Recognizing, based on the data processing features, the write operation as a data encryption operation.

Evaluating, based on a preset rule, execution of the data encryption operation may include:

Notifying regarding the data encryption operation, and after receiving feedback information confirming that the data encryption operation includes an attack behavior, blocking execution of the data encryption operation.

According to another aspect of the present disclosure, a behavior recognition apparatus is set forth, including:

A data operation behavior detecting module, configured to detect a data operation behavior;

A data processing feature obtaining module, configured to obtain data processing features of a data processing unit with regard to the data operation behavior; and

A data operation behavior recognizing module, configured to recognize the data operation behavior based on the data processing features.

According to another aspect of the present disclosure, a data processing apparatus is provided, including:

A data operation behavior detecting module, configured to detect a data operation behavior, and determine that the data operation behavior includes a write operation;

A data encryption operation determining module, configured to determine that the write operation is a data encryption operation; and

An evaluating module, configured to evaluate, based on a preset rule, execution of the data encryption operation.

According to another aspect of the present disclosure, a computing device is provided, including memory, a processor and a computer program stored on the memory and executable by the processor, wherein one or more of the aforementioned methods are implemented while the processor executes the computer program.

According to another aspect of the present disclosure, a computer-readable storage medium, having stored thereon a computer program, wherein one or more of the aforementioned methods are implemented while the computer program is executed by the processor.

According to example embodiments of the present disclosure, data operation behaviors may be detected, and data processing features of a data processing unit with regard to data operation behaviors obtained. Because the data processing features may describe a processing procedure of the data processing unit or characteristics exhibited by processing results while processing data based on the data operation behaviors, therefore based on the data processing features, data operation behaviors in accordance may be recognized, which is beneficial to performing governance upon the various data operation behaviors of an electronic device, preventing or blocking potentially hazardous data operation behaviors, exercising preventative measures, effectively reducing the likelihood of data loss on the electronic device or damage to the electronic device, and increasing security and reliability of data and the electronic device.

The above-mentioned description is merely an overview of technical solutions of the present disclosure. For a clearer understanding of techniques of the present disclosure, and to for implementation according to the contents of the description, and for a more evident grasp of the above-mentioned and other objectives, features and advantages of the present disclosure, particular manners of implementing the present disclosure are set forth below.

### BRIEF DESCRIPTION OF THE DRAWINGS

By reading the detailed description of the example manners of implementation of the below text, various other advantages and benefits will become clear to persons of ordinary skill in the art. The drawings are merely utilized for the obj ective of showing example manners of implementation, and shall not be considered as limiting the present disclosure. Throughout all the drawings, the same reference numerals indicate the same elements. Among the drawings:

FIG. 1 illustrates a flowchart of a behavior recognition method according to a first example embodiment of the present disclosure.

FIGS. 2A and 2B illustrate flowcharts of a behavior recognition method according to a second example embodiment of the present disclosure.

FIG. 3 illustrates a system structure diagram of an electronic device according to a second example embodiment of the present disclosure.

FIG. 4 illustrates a system structure diagram of another electronic device according to a second example embodiment of the present disclosure.

FIG. 5 illustrates a flowchart of a behavior recognition method according to a third example embodiment of the present disclosure.

FIG. 6 illustrates a flowchart of a data processing method according to a fourth example embodiment of the present disclosure.

FIG. 7 illustrates a flowchart of a data processing method according to an example embodiment of the present disclosure.

FIGS. 8A and 8B illustrate structural diagrams of a behavior recognition apparatus according to a fifth example embodiment of the present disclosure.

FIGS. 9A and 9B illustrate structural diagrams of a data processing apparatus according to a sixth example embodiment of the present disclosure.

FIG. 10 illustrates a structural diagram of an exemplary system according to an example embodiment of the present disclosure.

### DETAILED DESCRIPTION

Below, in reference to the drawings, exemplary embodiments of the present disclosure are described in further detail. Although the drawings illustrate exemplary embodiments of the present disclosure, it should be understood that the present disclosure may be implemented in various fashions, which shall not be limited by the example embodiments set forth herein. To the contrary, these example embodiments are provided for a more thorough understanding of the present disclosure, and moreover to convey the scope of the present disclosure to persons skilled in the art.

To facilitate an in-depth understanding of example embodiments of the present disclosure by persons skilled in the art, definitions of industry terminology included in example embodiments of the present disclosure shall first be introduced below.

Data operation behavior is behavior of operations performed by an electronic device or an external device upon data on the electronic device.

Herein, an external device is another device outside of the electronic device.

A data processing unit is a unit related to processing data, and may include a CPU (central processing unit) and memory.

Memory may include a cache, internal memory, external memory and such memory devices. Herein, a cache, or high-speed cache memory, may be installed on a CPU, providing a high-speed data buffer region for exchange of data between the CPU and internal memory, and may include a level 1 cache, a level 2 cache and a level 3 cache; internal memory may include RAM (random-access memory) and ROM (read-only memory); external memory may include a hard disk, a magnetic disk, flash memory and such memory devices. Of course, in practical applications, the memory devices may further include other types of memory devices, such as video memory on a display card.

Additionally, in practical applications, a data processing unit may further include other units related to data processing.

A data processing feature is a feature that arises from a procedure or result of a data processing unit performing data processing based on a data operation behavior, such as CPU frequency, CPU usage rates, usage rates of storage space in memory, read and write speeds of memory, and so on. Of course, in practical applications, a data processing feature may further include other features.

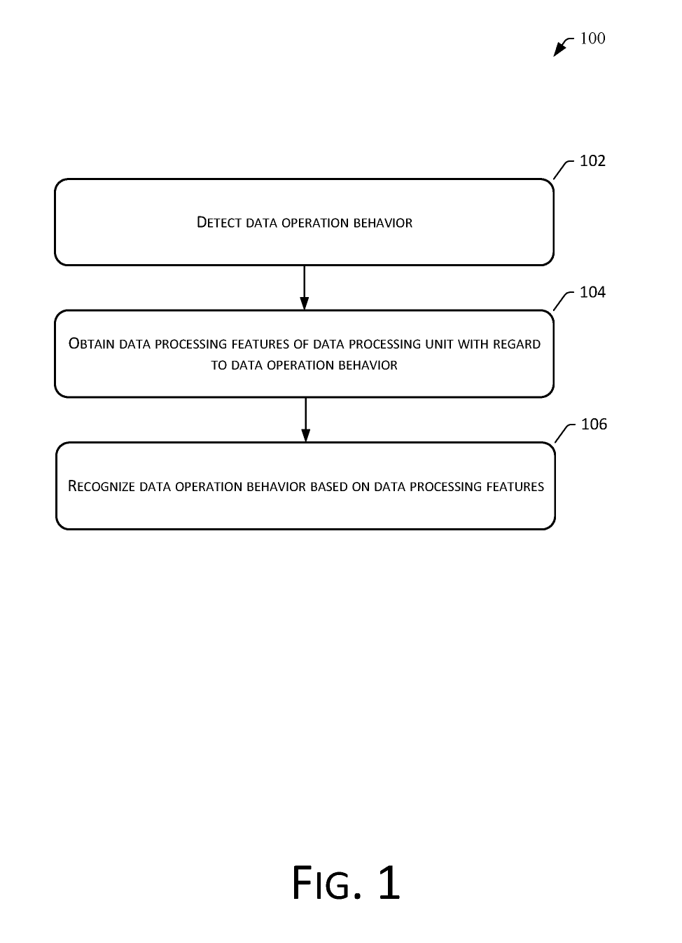

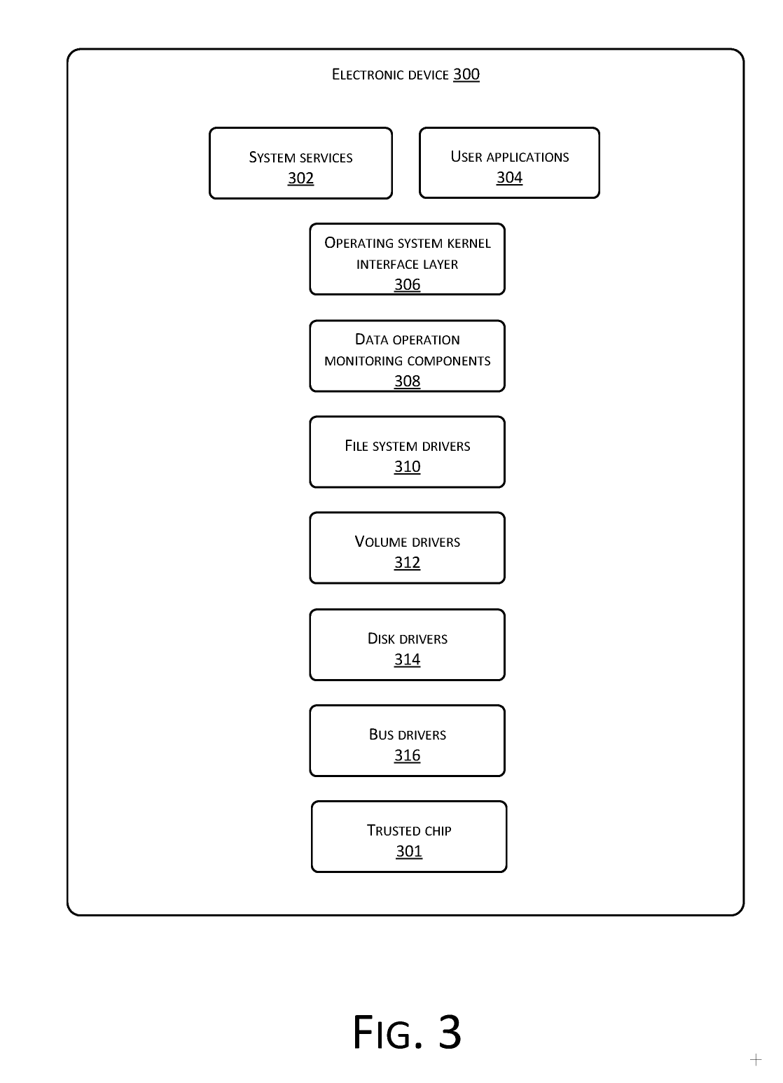

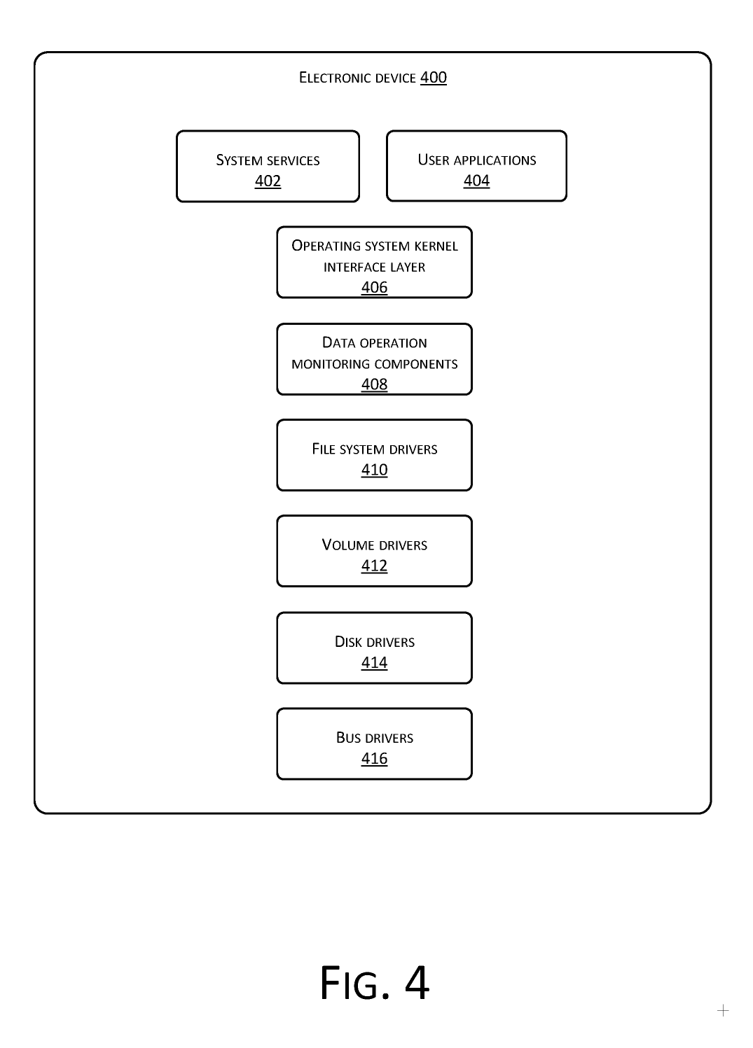

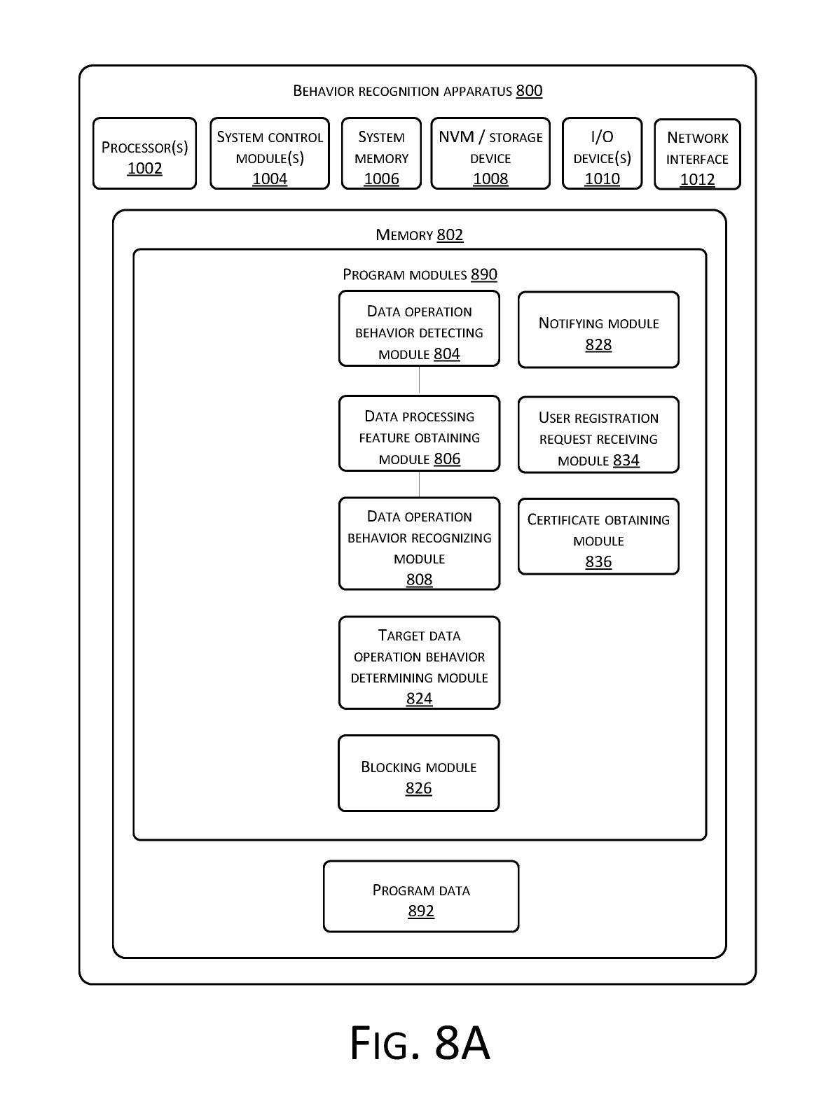

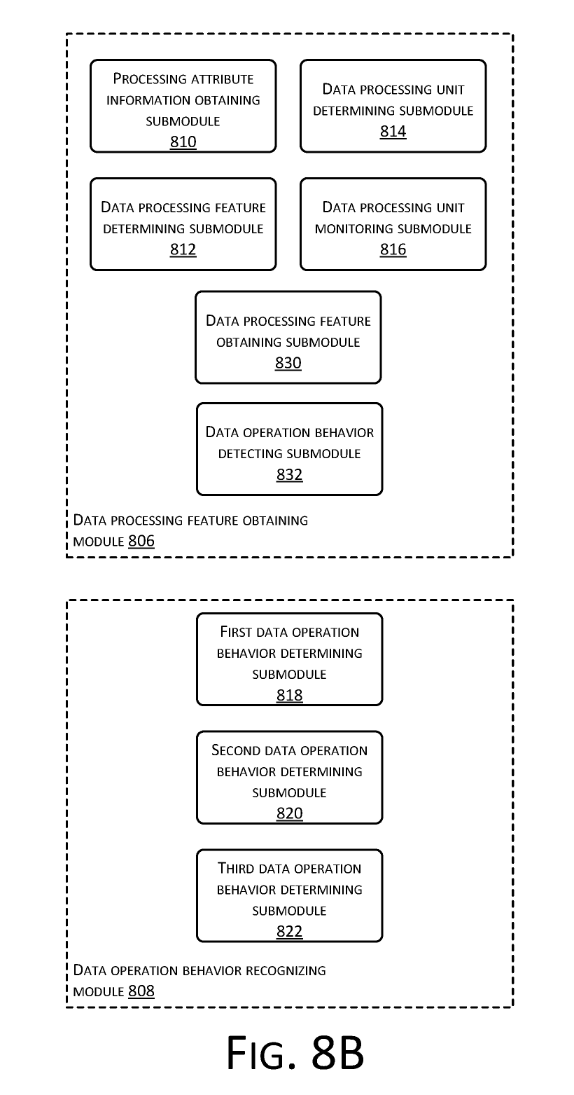

An electronic device may include a mobile phone, a smartwatch, a VR (virtual reality) device, a tablet computer, an e-book reader, an MP3 (Moving Picture Experts Group Audio Layer III) player, an MP4 (Moving Picture Experts Group Audio Layer IV) player, a laptop portable computer, an in-car computer, a desktop computer, a set-top box, a smart television, a wearable device and so on. Herein, an electronic device may include hardware, an operating system and user applications, where an operating system may directly control hardware execution and provide an operating system kernel interface to user applications, user applications send operation instructions to the operating system through the operating system kernel interface, and based on the operation instructions, indicating operations controlling hardware execution, data operation behaviors in accordance are implemented, processing data on the electronic device. The electronic device may interact with a remote server, obtaining a client terminal, a plugin, behavior recognition or data processing method services, further including any apparatus of the below FIGS. 8 to 10, having system structures of FIG. 3 or 4, implementing any corresponding method of FIGS. 1 to 2 and 5 to 7, thereby performing recognition upon behavior of the electronic device or processing data.

A client terminal may include at least one user application. The client terminal may execute on the electronic device, thereby implementing behavior recognition or data processing methods provided by example embodiments of the present disclosure.

A plugin may include those of a user application executing on an electronic device, thereby implementing behavior recognition or data processing methods provided by example embodiments of the present disclosure.

Example embodiments of the present disclosure may be applied to a setting of recognizing behavior with regard to data operations by electronic devices. In related technology, through the backup of data on electronic devices, the problems of data loss or device damage brought by Trojans or viruses and such malicious programs may be reduced, but this method may be limited by the amount of data that needs to be backed up and storage space on the electronic device, while at the same time data may only be restored to its state at the time of backup. With extensive limitations, it is difficult to ensure security and reliability of data or electronic devices. Therefore, example embodiments of the present disclosure provide a behavior recognition method. Because, while an electronic device is implanted with malicious programs, operations may be performed upon data on the electronic device, such as writing data or modifying data, and procedures of the above-mentioned data operations need to be processed through a CPU and memory and such data processing units, particulars of processing unit resource occupation while conducting different data operation behaviors will also be different. For example, additional writes to a malicious program may cause CPU usage to rise, data written to memory to expand, and so on, thereby exhibiting different data processing features. Thus, data operating behavior may be detected, obtaining data processing features of a data processing unit with regard to the data operation behavior, and then, based on data processing features corresponding to the data operation behavior, recognition is performed upon the data operation behavior. Beneficially, based on recognition results, governance is performed upon the various data operation behaviors of an electronic device, including determining whether the data operation behavior may harm security or reliability of data or the electronic device, and blocking potentially hazardous data operation behaviors. This facilitates the exercise of preventative measures, and effectively reduces the likelihood of data loss on the electronic device or damage to the electronic device, and increases security and reliability of data and the electronic device. Of course, in practical applications, based on other objectives, according to the above-mentioned behavior recognition methods, data operation behaviors having specific functions may be recognized—for example, recognizing only data operation behaviors that may be hazardous.

Example embodiments of the present disclosure may be implemented as a client terminal or plugin, and an electronic device may obtain from a remote server and install the client terminal or plugin, thereby through the client terminal or plugin implementing behavior recognition or data processing methods provided by example embodiments of the present disclosure. Of course, example embodiments of the present disclosure may also be deployed on a remote server in the form of software, and an electronic device may obtain behavior recognition or data processing services through accessing the remote server.

### First Example Embodiment

Referring to FIG. 1, a flowchart of a behavior recognition method 100 according to an exemplary embodiment of the present disclosure is illustrated, particular steps thereof including:

Step 102, detecting a data operation behavior.

Because an electronic device may process data on the electronic device through data operation behaviors, such as writing or modifying data, data processing during normal execution may be included therein, and hazardous data processing caused by Trojans and such malicious programs may also be included therein. Therefore, to facilitate subsequently recognizing data operation behaviors, which is beneficial to performing governance upon the various data operation behaviors of an electronic device, preventing or blocking potentially hazardous data operation behaviors, exercising preventative measures, effectively reducing the likelihood of data loss on the electronic device or damage to the electronic device, and increasing security and reliability of data and the electronic device, data operation behaviors may be detected.

Operation instructions received via an operating system kernel interface and originating from user applications may be monitored, thereby detecting data operation behaviors of user applications.

Step 104, obtaining data processing features of a data processing unit with regard to the data operation behavior;

Because different data operation behaviors may need to process different data, and different manners of processing may be utilized with regard to different data, particulars of data processing unit resource occupation will also be different, thereby exhibiting different data processing features. Thus, to facilitate the objectives of subsequently recognizing data operation behaviors through data processing features, and improving in advance security and reliability of data and the electronic device, data processing features of a data processing unit with regard to the data operation behavior may be obtained.

In the process of executing data operation behaviors, at least one of a CPU, memory, and such data processing units may be monitored, information resulting from monitoring being designated as data processing features.

Herein, data processing units may be monitored through hardware devices or software modules able to obtain CPU addresses of an electronic device and/or memory addresses in memory of an electronic device, that is, having access permissions to a CPU and/or memory. For example, a monitoring module may be set up and operated in an operating system kernel layer of the electronic device, the monitoring module having access permissions to a CPU and/or memory. Additionally, in practical applications, hardware devices or software modules utilized to monitor and obtain data processing features may also be utilized for detecting a data operation behavior in the aforementioned step 102.

Step 106, recognizing the data operation behavior based on the data processing features.

Because different data operation behaviors may correspond to different data processing features, a data operation behavior may be recognized based on data processing features.

At least one recognized data operation behavior, as well as corresponding data processing features, may be obtained in advance and designated as samples. Then, the aforementioned obtained data processing features are designated as to-be-recognized data processing features, and the to-be-recognized data processing features are compared to data processing features of the samples. If data processing features consistent with the to-be-recognized data processing features exists in the samples (or the to-be-recognized data processing features are present within the scope of the data processing features), then a recognition result of the data operation behavior corresponding to the data processing features may be designated as a recognition result of the data operation behavior corresponding to the to-be-recognized data processing features.

For example, given a detected data operation behavior 1, data processing features obtained with regard to data operation behavior 1 include CPU usage rate 90%, RAM usage rate 80%. Samples stored in advance include sample 1: data operation behavior 2, data processing features including CPU usage rate 90% and RAM usage rate 80%, a recognition result being “danger”; sample 2: data operation behavior 3, data processing features including CPU usage rate 10% and RAM usage rate 60%, a recognition result being “safe.” Because data processing features corresponding to data processing behavior 1 are the same as data processing features of sample 1, a recognition result of data operation behavior 2 of sample 1 may be determined as a recognition result of data operation behavior 1, and thus a recognition result of data operation behavior 1 is “danger.”

Of course, in practical applications, data operation behaviors may be recognized based on data processing features in other manners, such as through recognition by classification or machine learning.

After recognizing the data operation behavior, to perform governance based on the recognition result upon the various data operation behaviors of the electronic device, exercising preventative measures, effectively reducing the likelihood of data loss on the electronic device or damage to the electronic device, and further improving security and reliability of data and the electronic device, further processing may be performed based on the recognition result. For example, the recognition result is displayed for a user, and a processing instruction submitted by the user based on the displayed recognition result is received; alternatively, according to a preset processing strategy, governance is performed based on a data operation behavior corresponding to the recognition result; alternatively, the recognized data operation behavior is stored by classification, facilitating subsequent analysis or other operations.

A processing instruction is utilized to process a data operation behavior, and may be triggered by a user through executing a clicking operation or a touch operation and such preset operations.

A processing strategy is a strategy for processing of data procession behaviors, and may be determined by an electronic device in advance, such as being derived from receiving a user submission.

According to example embodiments of the present disclosure, data operation behaviors may be detected, and data processing features of a data processing unit with regard to data operation behaviors obtained. Because the data processing features may describe a processing procedure of the data processing unit or characteristics exhibited by processing results while processing data based on the data operation behaviors, therefore based on the data processing features, data operation behaviors in accordance may be recognized, which is beneficial to performing governance upon the various data operation behaviors of an electronic device, preventing or blocking potentially hazardous data operation behaviors, exercising preventative measures, effectively reducing the likelihood of data loss on the electronic device or damage to the electronic device, and increasing security and reliability of data and the electronic device.

### Second Example Embodiment

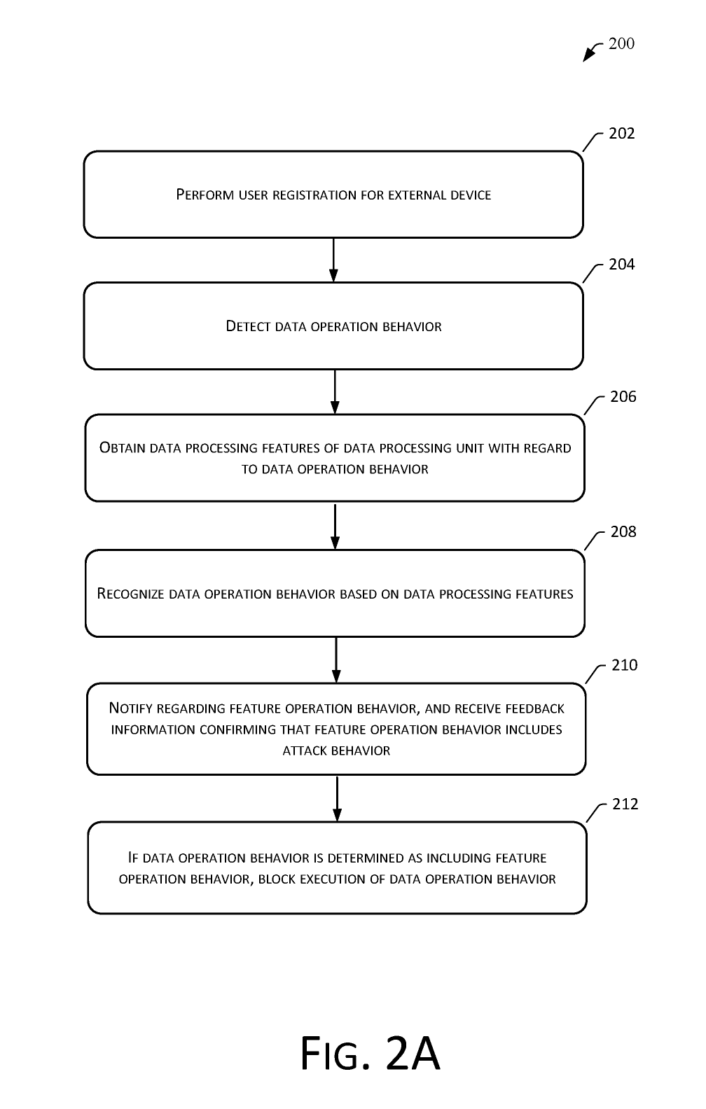

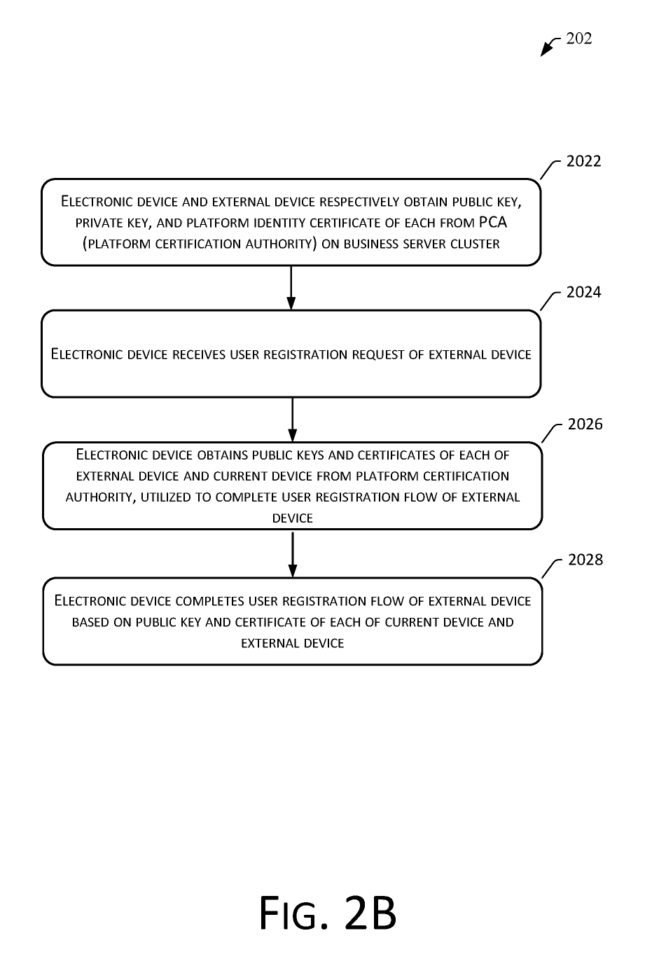

Referring to FIGS. 2A and 2B, flowcharts of a behavior recognition method 200 according to an exemplary embodiment of the present disclosure are illustrated, particular steps thereof including:

Step 202, performing user registration for an external device.

To facilitate operational instructions based on an external device, to process data on a current electronic device, user registration for an external device may first be performed on the electronic device.

Herein, user registration for an external device may be performed by the below steps:

Sub-step 2022, the electronic device and the external device respectively obtaining a public key, a private key, and a platform identity certificate of each from a PCA (platform certification authority) on a business server cluster.

Herein, the PCA provides the private key, public key, and platform identity certificate of the device to the device, and also provides the private key and platform identity certificate of the requesting device to the device, thereby completing authentication between devices.

For example, given an external device C, and a current electronic device S, C may obtain public key AIK_{pk_C}, private key AIK_{priv_C}, and platform identity certificate Cert_AIK_{C} from a PCA, and S may obtain public key AIK_{pk_S}, private key AIK_{priv_S}, and platform identity certificate Cert_AIKs from the PCA. Of course, the PCA also stores a platform identity public key AIK_{pk_PCA} and a platform identity private key AIK_{priv_PCA} of the PCA.

According to example embodiments of the present disclosure, to facilitate the electronic device subsequently verifying safety of the external device, as well as to securely protect private keys and such sensitive information, with regard to an electronic device, the public key and private key of the current device may be saved on a built-in trusted chip.

FIG. 3 illustrates a system structure of an electronic device 300, including a trusted chip 301 TPCM (Trusted Platform Control Module) or TPM (Trusted Platform Module) and further including system services 302, user applications 304, an operating system kernel interface layer 306, data operation monitoring components 308, file system drivers 310, volume drivers 312, disk drivers 314, and bus drivers 316.

System services 302 are programs, routines or processes executing particular system functions, supporting user applications 304 and the like.

An operating system kernel interface layer 306 is utilized to provide an interface between user applications 304 and system services 302 with an operating system kernel.

Data operation monitoring components 308 are components which obtain data processing requests, obtain data processing features, detect data operation behaviors, and recognize data operation behaviors.

File system drivers 310 are programs related to file processing, including creating, modifying, saving and deleting files and the like.

Volume drivers 312 are programs in an operating system that provide storage space operation interfaces to a file system.

Disk drivers 314 are programs that drive disks.

Bus drivers 316 are programs that drive buses.

Of course, in practical applications, an electronic device may further save a platform identity certificate on a trusted chip.

Additionally, according to another optional example embodiment of the present disclosure, FIG. 4 illustrates a system structure of an electronic device 400, and by FIG. 4 it may be known that the electronic device 400 does not include a trusted chip but does include system services 402, user applications 404, an operating system kernel interface layer 406, data operation monitoring components 408, file system drivers 410, volume drivers 412, disk drivers 414, and bus drivers 416, which are similar to analogous elements of the electronic device 300 of FIG. 3. Now, the electronic device 400 may store an obtained public key and private key in other locations.

Sub-step 2024, the electronic device receiving a user registration request of the external device.

The external device may send a user registration request to the electronic device, thereby becoming an authorized user.

A user registration request is a request to be registered on the electronic device to become an authorized user. The user registration request may carry a public key and platform identity certificate of the external device. Of course, in practical applications, the user registration request may further carry other information which may be related to user registration.

Sub-step 2026, the electronic device obtaining public keys and certificates of each of the external device and the current device from a platform certification authority, utilized to complete a user registration flow of the external device.

For mutual verification between the electronic device and the external device, improving security and reliability of registration, the electronic device may obtain public keys and certificates of each of the external device and the external device from a platform certification authority.

Sub-step 2028, the electronic device completing a user registration flow of the external device based on the public key and the certificate of each of the current device and the external device.

For mutual verification between the electronic device and the external device, improving security and reliability of registration, the electronic device may, based on the public key and a platform identity certificate (“certificate”) of each of the current device and the external device, register the external device, and after successful registration, the external device is an authorized device that may perform operations upon data of the electronic device.

The electronic device may compare the public key and platform identity certificate of the external device obtained from the PCA to a public key and platform identity certificate provided by the external device, verification passing if the same, and verification not passing if not. Likewise, the external device may also verify the electronic device according to a same manner. After verification mutually passes, the electronic device may register the external device, and store the public key and platform identity certificate of the external device.

Step 204, detecting a data operation behavior.

Herein, a manner of detecting a data operation behavior may refer to the aforementioned related description, which shall not be reiterated herein.

According to example embodiments of the present disclosure, to reduce the possibility that an external device may write a malicious program onto the electronic device or execute other data operation behaviors that may harm security of the electronic device, and improve security and reliability of data and the electronic device, a data operation behavior of the external electronic device may be detected.

By the aforementioned it may be known that an external electronic device may be registered on the electronic device, so therefore, based on a user identifier corresponding to the data operation behavior, the operation behavior may be filtered, thereby detecting data operation behaviors of the external device.

Herein, a user identifier is utilized to identify a user (that is, an external device), where the user identifier may be provided by an external device, or may be assigned to the external device by the electronic device upon successfully registering the external device.

Additionally, according to another optional example embodiment of the present disclosure, instead, based on a user identifier corresponding to the data operation behavior, data operation behaviors may be detected with regard to at least one particular external device, and then, through a following method, data operation behaviors of the at least one particular external devices may be recognized, achieving the objectives of more precise detection and recognition upon data operation behaviors.

Of course, in practical applications, data operation behaviors may be detected according to other strategies, such as detecting all data operation behaviors, or detecting data operation behaviors internal to an originating electronic device.

Step 206, obtaining data processing features of a data processing unit with regard to the data operation behavior.

Herein, a manner of obtaining data processing features of a data processing unit with regard to data operation behaviors may refer to the aforementioned related description, which shall not be reiterated herein.

According to example embodiments of the present disclosure, in order to obtain as many data processing features produced by the data operation behavior as possible, facilitating subsequently accurately recognizing data operation behaviors, that is, improving accuracy of recognizing data operation behaviors, at least one data processing unit involved in a data processing procedure may be determined, and data processing features of the at least one data processing unit monitored.

Through receiving a data processing unit designated by a user, the designated data processing unit may be determined as the at least one data processing unit; alternatively, data during a data processing procedure may be detected or tracked, thereby determining at least one data processing unit involved in the data processing procedure. Of course, in practical applications, at least one data processing unit involved in a data processing procedure may be determined in other manners.

According to example embodiments of the present disclosure, because data may be stored on external memory, and during processing may be temporarily stored on internal memory and a cache, a processor may obtain the data for processing from internal memory or a cache. Therefore, in order to obtain as many data processing features produced by the data operation behavior as possible, adding to the diversity of data processing feature sources, facilitating subsequently, based on data processing features of one or more data processing units, flexibly and accurately recognizing data operation behaviors, and improving reliability of obtained data processing features as well as accuracy of recognizing data operation behaviors, the data processing units include external memory, internal memory, a cache or a processor.

Herein, a processor may include an aforementioned CPU.

According to an example embodiment of the present disclosure, to ensure that processors and memory may be accessed, a processor address or a memory address may be obtained, thereby improving the reliability of obtained data processing features, and then improving the reliability of subsequently recognizing data operation behavior. Through a monitoring unit of an operating system kernel, the data processing features may be obtained, the monitoring unit having monitoring authorization with regard to the data processing unit.

A monitoring unit may be deployed in the electronic device in advance by a hardware or software fashion. For example, the monitoring unit may include an aforementioned data operation monitoring component set up in an operating system kernel.

According to example embodiments of the present disclosure, because a data processing procedure needs to pass through a data processing unit in order to process data, data before and after processing may become changed. Also, the data processing unit may perform data processing with regard to more than one data operation behaviors. Therefore, in order to accurately derive data processing features of a particular data processing behavior, processing attribute information of the data processing unit may be obtained, and change data of processing attribute information before and after data processing determined, and designated as data processing features of the data processing behavior.

Processing attribute information is information describing attributes possessed by a data processing unit and/or the data being processed.

Processing attribute information before and after data processing may be respectively obtained, and compared to the obtained processing attribute information, thereby deriving change data of the processing attribute information, where the change data may be utilized to describe changes to the data before and after processing, or describe resources occupied by data processing.

Additionally, according to another optional example embodiment of the present disclosure, the obtained processing attribute information of the data processing unit may be directly designated as data processing features of a data operation behavior.

According to example embodiments of the present disclosure, to improve accuracy of obtained processing attribute information, and then improve accuracy of the obtained data processing features, the processing attribute information may include at least one of data attribute information, interaction status information between processing units, unit execution status information, and unit attribute information. Likewise, the data processing features may include at least one of data change information, interaction change information, execution status change information, and unit attribute change information of processing units.

Data attribute information is information describing attributes possessed by data being processed. For example, the data attribute information may include data name, extension (that is, data format), data size, information entropy (average quantity of data after releasing redundant data), and storage location. Likewise, data change information may include at least one of whether a name has changed (herein, yes is expressed as 1, and no is expressed as 0), whether an extension has changed, a magnitude of size change, and whether storage location has changed, thereby describing changes caused by data processing behaviors with regard to the data processing. Of course, in practical applications, data attribute information may further include other information capable of describing attributes possessed by data being processed.

For example, a data name of data A is A, an extension is TXT, data size is 20 kb (kilobytes), information entropy is 60 bits, and storage location is drive D. After processing data A according to data operation behavior 3, the data name of data A is AS, the extension is INI, the data size is 25 kb, the information entropy is 125 bits, and storage location is drive C. Thus, its name change is 1, extension change is 1, magnitude of size change is 5 kb, magnitude of information entropy change is 65 bits, and storage location change is 1; all may be designated as data processing features corresponding to data operation behavior 3.

Interaction status information between processing units describes status information of interactions between any two processing units. For example, taking a CPU and internal memory as an example, interaction status information may include at least one of a data exchange rate, a rate of the CPU writing to the internal memory, and a rate of the CPU reading from the internal memory. Likewise, interaction status information may include at least one of a magnitude of data exchange rate change, a magnitude of rate change of the CPU writing to the internal memory, and a magnitude of rate change of the CPU reading from the internal memory. Alternatively, interaction status information between the CPU and memory may further include a frequency and/or location of obtaining data from the internal memory.

Unit execution status information is information describing a status of data processing unit execution. Different data processing units may have different unit execution status information. For example, taking a CPU as an example, its unit execution status information may include at least one of a CPU usage rate, a CPU frequency, a number of processes currently included, a number of threads currently included and a number of handles currently included. Likewise, execution status change information may include at least one of a magnitude of CPU usage rate change, a magnitude of CPU frequency change, a magnitude of number change of processes currently included, a magnitude of number change of threads currently included, and a magnitude of number change of handles currently included. Taking a hard disk as an example, its unit execution status information may include at least one of a transfer rate, a write speed and a read speed. Likewise, execution status change information may include at least one of a magnitude of transfer rate change, a magnitude of write speed change and a magnitude of read speed change.

For example, before a data processing unit performs data processing with regard to data operation behavior 3, a CPU usage rate was 40%, a CPU frequency was 1.61 GHz (gigahertz), a number of processes was 146, a number of threads was 1,551, and a number of handles was 83,436. After starting data processing with regard to data operation behavior 3, a CPU usage rate was 70%, a CPU frequency was 2.61 GHz, a number of processes was 148, a number of threads was 1,651, and a number of handles was 85,436. Then, a magnitude of CPU usage rate change is 30%, a magnitude of CPU frequency change is 1 GHz, a magnitude of number change of currently included processes is 2, a magnitude of number change of currently included threads is 100, and a magnitude of number change of currently included handles is 2,000; these may be the resources occupied by data processing with regard to data operation behavior 3, and thereby may be designated as data processing features corresponding to data operation behavior 3.

Unit attribute information is information describing attributes possessed by data processing units. Different data processing units may have different unit attribute information. Relative to unit execution status information, unit attribute change information may be static or slow to change. For example, taking a hard disk as an example, unit attribute information may include at least one of a magnitude of storage space occupation (or magnitude of remainder), a rate of storage space occupation, and a file system format of the storage space. Taking a cache as an example, unit attribute information may include at least one of a magnitude of level 1 cache occupation (or magnitude of remainder), a magnitude of level 2 cache occupation (or magnitude of remainder), and a magnitude of level 3 cache occupation (or magnitude of remainder). Taking internal memory as an example, unit attribute information may include at least one of a magnitude of internal memory occupation (or magnitude of remainder) and an internal memory occupation rate.

For example, before a data processing unit performs data processing with regard to data operation behavior 3, an internal memory occupation rate was 40%, and after starting data processing with regard to data operation behavior 3, an internal memory occupation rate was 60%. Then, a magnitude of internal memory occupation rate change is 20%; this may be the resources occupied by data processing with regard to data operation behavior 3, and thereby may be designated as data processing features corresponding to data operation behavior 3.

Additionally, in practical applications, the above-mentioned data processing features or processing attribute information may be further utilized in electronic device execution, to evaluate execution status of the electronic device, facilitating the timely discovery of abnormalities that may appear for an electronic device, to protect the electronic device.

For example, based on unit attribute information of a CPU, unit execution status information, interaction status information between the CPU, internal memory, and other data processing units, as well as changes in the above-mentioned information, security of CPU startup and executions in commercial activity is determined, as well as security of commercial activity being executed.

Step 208, recognizing the data operation behavior based on the data processing features.

Herein, a manner of recognizing the data operation behavior based on the data processing features may refer to the aforementioned related description, which shall not be reiterated herein.

By the aforementioned it may be known that data processing features may include at least one parameter. Thereby, while processing data based on a data operation behavior, the data operation behavior may be recognized based on at least one parameter included in the data processing features, such as randomly selecting a parameter to recognize the data operation behavior, or selecting more than one parameter together to recognize the data operation behavior.

According to example embodiments of the present disclosure, in order to recognize some particular type of data operation behavior, such as a malicious file encryption behavior, or data theft, and such data operation behaviors that may harm the security of data and electronic devices, and thereby performing governance over the data operation behavior or taking appropriate processing measures in a targeted manner, to further ensure security and reliability of data and electronic devices, improve data processing efficiency, or other objectives, based on the data processing features satisfying target data processing features corresponding to the data operation behavior, the data operation behavior may be determined as including a feature operation behavior.

A feature operation behavior may be a particular data operation behavior determined in advance.

For example, the feature operation behavior is a data encryption operation.

A target data processing feature is a data processing feature corresponding to a feature operation behavior.

An electronic device may determine a feature operation behavior in advance, obtaining data processing features corresponding to the feature operation behavior as target data processing features. Thereby, data processing features derived from monitoring may be compared to the target data processing features; if the same, a data operation behavior corresponding to the data processing features is determined as including the feature operation behavior, and if not the same, a data operation behavior corresponding to the data processing features is determined as not including the feature operation behavior.

According to example embodiments of the present disclosure, in order to improve accuracy of obtaining derived target data processing features, thereby improving accuracy of recognizing data operation behaviors, the target data processing features may be obtained in at least one manner among statistical analysis, machine learning, and behavior pattern analysis.

If target data processing features are obtained in a statistical analysis manner, multiple data operation behaviors and corresponding data processing features may be obtained. By clustering processing and such manners, the multiple data operation behaviors are classified, a feature operation behavior is determined among classification results, and then the data processing features corresponding to the feature operation behavior are determined as target data processing features.

If target data processing features are obtained in a machine learning manner, by a machine learning model, data processing features corresponding to the feature operation behavior are processed, thereby deriving target data processing features.

A behavior pattern is a manner by which a data processing unit processes data with regard to a data operation behavior. For example, the behavior pattern may include processing flow of data processing, interaction procedures between data processing units, and the like. To obtain target data processing features by behavior pattern analysis, processing flow of data processing with regard to the feature operation behavior, interaction procedures between data processing units, and the like may be analyzed, and the results of the analysis designated as target data processing features.

By the aforementioned it may be known that data processing features may include more than one parameter, and when they are entirely the same as each parameter included in the target data processing features, or within the range of each parameter included in the target data processing features, the data processing features and the target data processing features are determined as consistent, and otherwise, the data processing features and the target data processing features are determined as inconsistent. Of course, in practical applications, to improve accuracy of evaluating whether data processing features and target data processing features are consistent, thereby improving accuracy of data operation behavior recognition, each parameter included by data processing features and target data processing features may be respectively compared, where a comparison result of each parameter is recorded as 1 if consistent and recorded as 0 otherwise. Based on a weight of each parameter, comparison results of each parameter are summed, a derived sum result being a comparison result with regard to the data processing feature. If the sum result is greater than a preset threshold, the data processing features and the target data processing features are determined as consistent, and otherwise, the data processing features and the target data processing features are determined as inconsistent.

A preset threshold may be determined in advance, such as derived by receiving a submitted numerical value.

For example, target data processing features include a magnitude of information entropy change of 50-80 bits, and data processing features corresponding to data operation behavior 3 include a magnitude of information entropy change of 65 bits, within the range of the magnitude of information entropy change included in the target data processing features, so data operation behavior 3 is determined as the feature data operation behavior. Alternatively, target data processing features include a magnitude of information entropy change of 50-80 bits, a magnitude of CPU usage rate change of 25-100%, and a magnitude of internal memory usage rate change of 30-100%, and data processing features corresponding to data operation behavior 3 include a magnitude of information entropy change of 65 bits, a magnitude of CPU usage rate change of 30%, and a magnitude of internal memory usage rate change of 20%. By comparing data processing features corresponding to data operation behavior 3 with the target data processing features it may be known that, among data processing features corresponding to data operation behavior 3, a magnitude of internal memory usage rate change is the only one not within a range of the target data processing features; this number being less than half of 3, the number of data processing features, thus data operation behavior 3 is determined as the feature data operation behavior.

Step 210, notifying regarding the feature operation behavior, and receiving feedback information confirming that the feature operation behavior includes an attack behavior.

Because an attack behavior may harm security and reliability of an electronic device or data thereon, appropriate governance measures may need to be taken. Therefore, to facilitate improved accuracy in recognizing featured operation behaviors, and facilitate subsequent processing of the feature operation behavior, a user may be notified of the feature operation behavior, so as to have the user confirm the feature operation behavior.

Notification regarding the feature operation behavior may be performed by at least one manner among an image, voice and vibration, and based on the notification, feedback information of a user is received.

For example, notification regarding the feature operation behavior may be by a pop-up window manner, the pop-up window including therein text information describing the feature operation behavior, and including a confirm button and a deny button, feedback information of a user being received based on the confirm button or the deny button. If a click operation of a user is received based on the confirm button, then the received feedback information is determined as confirming the feature operation behavior as including an attack behavior; if a click operation of a user is received based on the deny button, then the received feedback information is determined as denying the feature operation behavior as including an attack behavior.

Additionally, according to another optional example embodiment of the present disclosure, to reduce interaction with users, improve efficiency of taking measures with regard to data operation behaviors, and reduce on a timely basis loss that may be suffered by electronic devices or data, a user may not be notified, and instead the below-mentioned step 212 is directly executed; that is, step 210 is an optional step.

Step 212, if the data operation behavior is determined as including the feature operation behavior, blocking execution of the data operation behavior.

When a feature operation behavior is an attack behavior, and recognition determines that the data operation behavior includes the feature operation behavior, then the data operation behavior may harm security and reliability of the electronic device or data thereon. Thereby, in order to reduce harm that the data operation behavior may cause for the electronic device or data as much as possible, ensuring security and reliability of the electronic device and data, execution of the data operation behavior may be blocked.

Herein, a process or thread corresponding to data processing with regard to the data operation behavior may be stopped; alternatively, the data operation behavior may be prevented from writing data, thereby preventing execution of the data operation behavior.

According to example embodiments of the present disclosure, first, a data operation behavior may be detected, and data processing features of a data processing unit with regard to the data operation behavior obtained. Because the data processing features may describe characteristics exhibited by a processing procedure or by processing results of a data processing unit during data processing based on the data operation behavior, therefore, based on the data processing features, the relevant data operation behavior may be recognized, which is beneficial for performing behavior governance upon each data operation behavior of an electronic device based on the recognition results, preventing or ending potentially hazardous data operation behaviors, exercising preventative measures, effectively reducing the likelihood of data loss on the electronic device or damage to the electronic device, and increasing security and reliability of data and the electronic device.

Second, by monitoring a data processing unit with a monitoring unit having monitoring authorization with regard to the data processing unit, reliability of obtaining derived data processing features is improved, thereby improving reliability of recognizing data operation behaviors.

Additionally, data processing units may include processors and memory, where memory may include external memory, internal memory and a cache, and thereby data processing features may be obtained from one or more data processing units, adding to the diversity of data processing feature sources, facilitating flexibly, based on data processing features of one or more data processing units, recognizing data operation behaviors, and improving reliability of obtained data processing features as well as accuracy of recognizing data operation behaviors.

Additionally, obtained data processing features may be compared with target data processing features corresponding to a feature operation behavior, and thereby a data operation behavior including the feature operation behavior may be recognized, ensuring that governance may be performed over the data operation behavior or appropriate processing measures may be taken in a targeted manner, further ensuring security and reliability of the electronic device and data.

Additionally, with regard to a data operation behavior that may include an attack behavior, execution of the data operation behavior may be blocked, thereby reducing harm that the data operation behavior may cause for the electronic device or data as much as possible, further ensuring security and reliability of the electronic device and data.

### Third Example Embodiment

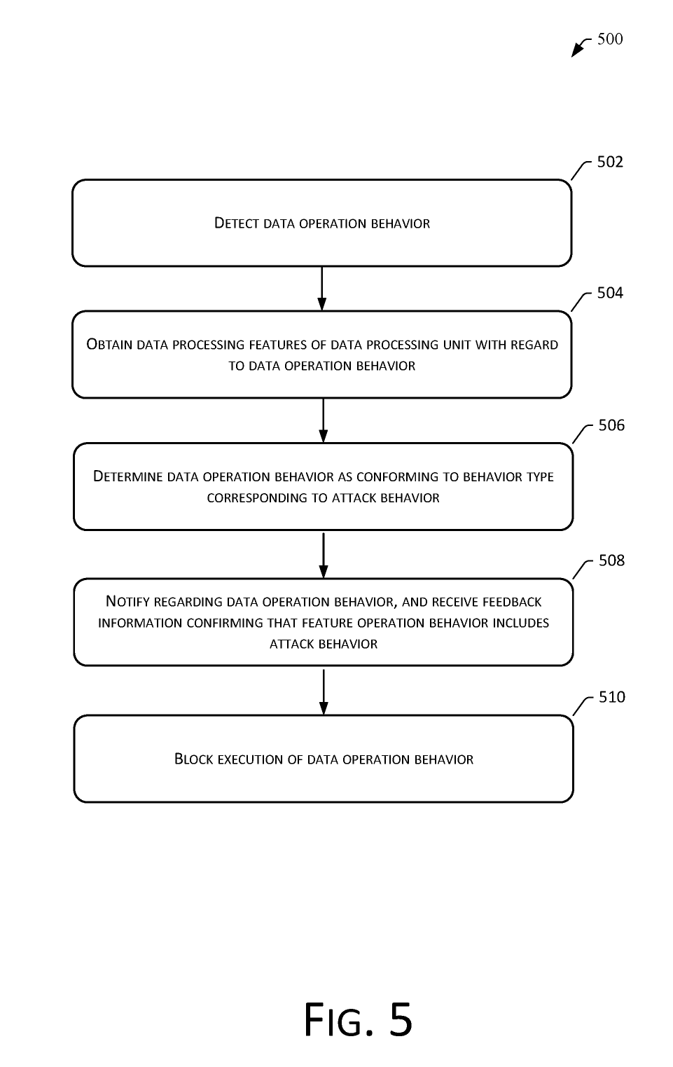

Referring to FIG. 5, a flowchart of a behavior recognition method 500 according to an exemplary embodiment of the present disclosure is illustrated, particular steps thereof including:

Step 502, detecting a data operation behavior.

Herein, a manner of detecting a data operation behavior may refer to the aforementioned related description, which shall not be reiterated herein.

Step 504, obtaining data processing features of a data processing unit with regard to the data operation behavior.

Herein, a manner of obtaining data processing features of a data processing unit with regard to data operation behaviors may refer to the aforementioned related description, which shall not be reiterated herein.

Step 506, determining the data operation behavior as conforming to a behavior type corresponding to an attack behavior.

To be able to take appropriate processing measures with regard to an operation behavior that may cause harm to an electronic device or data thereon on a timely basis, ensuring security and reliability of the electronic device and data, whether the data operation behavior conforms to a behavior type of an attack behavior may be determined.

Data operation behaviors conforming to conforming to a behavior type of an attack behavior may be designated as feature operation behaviors, and data processing features corresponding to the data operation behavior designated as target data processing features. If so, then the data operation behavior is determined as conforming to a behavior type corresponding to an attack behavior, and otherwise the data operation behavior is determined as not conforming to a behavior type corresponding to an attack behavior.

Herein, a manner of recognizing whether a data operation behavior includes a feature operation behavior may refer to the aforementioned related description, which shall not be reiterated herein.

According to example embodiments of the present disclosure, because an attack on an electronic device may write data on the electronic device, such as a Trojan and the like, therefore to improve accuracy of recognizing a data operation behavior, the data operation behavior may be determined as including a data write operation.

Computer instructions or code included by the data operation behavior may be analyzed, determining whether the computer instructions or code are instructions or code related to writing data; if so, the data operation behavior is determined as including a data write operation, and otherwise the data operation behavior is determined as not including a data write operation.

According to example embodiments of the present disclosure, because an illicit user encrypting data on an electronic device may result in difficulty for a legitimate user of the electronic device in obtaining the data, thereby resulting in data loss and causing the user to suffer loss, therefore, to ensure security and reliability of an electronic device and data, based on the data processing features satisfying data processing features corresponding to data encryption operations, the data operation behavior may be determined as including a data encryption operation.

A data encryption operation may be determined as a feature operation behavior, and data processing features corresponding to a data encryption operation designated as target data processing behaviors, and according to the aforementioned manner whether the data operation behavior includes the data encryption operation is recognized.

Of course, in practical applications, because recognizing a data write operation will be simpler than recognizing whether some particular data operation is included, therefore, to conserve recognition upon read operations, reduce complexity of recognizing the data operation behavior, and improve recognizing efficiency, whether the data operation behavior is a write operation may be recognized first, and after determining that the data operation behavior is a write operation, then whether the data operation behavior includes a data encryption operation is recognized.

Step 508, notifying regarding the data operation behavior, and receiving feedback information confirming that the feature operation behavior includes an attack behavior.

Because an attack behavior may harm security and reliability of an electronic device or data thereon, appropriate governance measures may need to be taken. Therefore, to facilitate improved accuracy in recognizing featured operation behaviors, and facilitate subsequent processing of the feature operation behavior, a user may be notified of the data operation behavior, so as to have the user confirm the feature operation behavior.

Herein, a manner of notifying regarding the data operation behavior may be the same as the aforementioned notifying regarding a feature operation behavior, which shall not be reiterated herein.

Additionally, according to another optional example embodiment of the present disclosure, to reduce interaction with users, improve efficiency of taking measures with regard to data operation behaviors, and reduce on a timely basis loss that may be suffered by electronic devices or data, a user may not be notified, and instead the below-mentioned step 510 is directly executed; that is, step 508 is an optional step.

Step 510, blocking execution of the data operation behavior.

When a data operation behavior is an attack behavior, it may harm security and reliability of an electronic device or data thereon. Therefore, to ensure security and reliability of the electronic device and data, execution of the data operation behavior may be blocked.

Herein, a manner of preventing execution of the data operation behavior may refer to the aforementioned related description, which shall not be reiterated herein.

According to example embodiments of the present disclosure, first, a data operation behavior may be detected, and data processing features of a data processing unit with regard to the data operation behavior obtained. Because the data processing features may describe characteristics exhibited by a processing procedure or by processing results of a data processing unit during data processing based on the data operation behavior, therefore, based on the data processing features, the relevant data operation behavior may be recognized, which is beneficial for performing behavior governance upon each data operation behavior of an electronic device based on the recognition results, preventing or ending potentially hazardous data operation behaviors, exercising preventative measures, effectively reducing the likelihood of data loss on the electronic device or damage to the electronic device, and increasing security and reliability of data and the electronic device.

Second, whether a data operation behavior includes a data encryption operation may be recognized, facilitating subsequently preventing illicit data encryption operations on a timely basis, ensuring security and reliability of an electronic device and data.

Additionally, after initially recognizing the data operation behavior as a write operation, whether the data operation behavior includes a data encryption behavior may be further recognized, reducing recognition of read operations, lowering complexity of recognizing the data operation behavior, and improving recognition efficiency.

### Fourth Example Embodiment

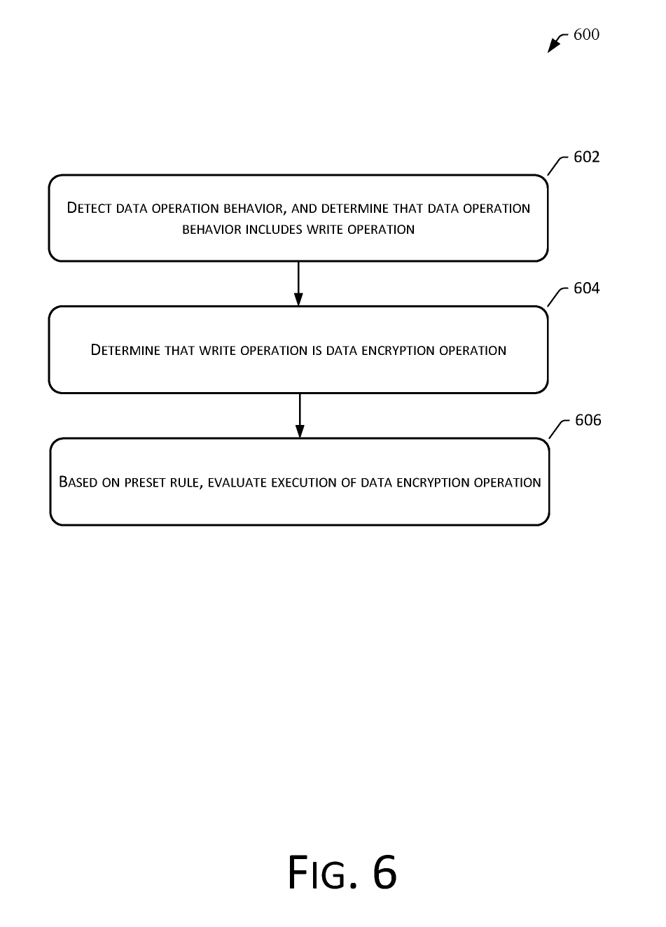

Referring to FIG. 6, a flowchart of a data processing method 600 according an exemplary embodiment of the present disclosure is illustrated, particular steps thereof including:

Step 602, detecting a data operation behavior, and determining that the data operation behavior includes a write operation.

Because an electronic device may process data on the electronic device through a data operation behavior, such as writing or modifying data and the like, data operation behaviors writing malicious programs or other data onto the electronic device may be included therein, which may thereby cause data loss or damage to the electronic device, causing users to suffer losses. Therefore, to facilitate subsequently recognizing data operation behaviors, thereby preventing data operation behaviors that may harm the electronic device or data security on a timely basis, effectively reducing the likelihood of data loss on the electronic device or damage to the electronic device, and increasing security and reliability of data and the electronic device, data operation behaviors may be detected and that data operations include write operations may be determined.

Herein, a manner of detecting a data operation behavior as well as determining that a data operation behavior includes a write operation may refer to the aforementioned related description, which shall not be reiterated herein.

Step 604, determining that the write operation is a data encryption operation.

Because, when a data operation is a write operation, it may include implanting a Trojan and such malicious programs, especially when the write operation is a data encryption operation, which may perform malicious encryption upon data (such as encryption by ransomware) which may cause data loss or cause a user to suffer loss, therefore, to ensure security and reliability of an electronic device and data, and ensure user interests, whether the write operation is a data encryption operation may be determined.

According to example embodiments of the present disclosure, because different data operation behaviors may have corresponding data processing features, therefore in order to perform recognition through data processing features upon relevant data operation behaviors, improving accuracy and reliability of recognition, data processing features of a data processing unit with regard to the write operation may be obtained, and based on the data processing features the write operation may be recognized as a data encryption operation.

Herein, a manner of obtaining data processing features of a data processing unit with regard to a write operation may be the same as a manner of obtaining data processing features of a data processing unit with regard to a data operation behavior; a manner of, based on data processing features, recognizing whether a data operation behavior which is a write operation is a data encryption operation may refer to the aforementioned related descriptions; these shall not be reiterated herein.

Of course, in practical applications, whether a write operation is a data encryption operation may be determined by other manners. For example, a user may be notified regarding the write operation, and after receiving feedback information confirming that the write operation is a data encryption operation, the write operation is determined as a data encryption operation.

Herein, a manner of notifying regarding a write operation may be the same as the aforementioned notifying regarding a data operation behavior, which shall not be reiterated herein.

Step 606, based on a preset rule, evaluating execution of the data encryption operation.

To reduce the problem of data loss or damage to an electronic device that may result from data encryption operations belonging to malicious encryption, ensuring security and reliability of data and the electronic device, and ensuring user interests, the data encryption operation may be evaluated.

A preset rule is a rule for evaluating execution of data encryption operations, where the preset rule may be derived by determination in advance, such as derived from the electronic device receiving a rule submitted by a user or related technical personnel. Of course, in practical applications, it may also be derived by other manners of obtaining.

For example, a preset rule may include directly evaluating execution of the data encryption operation.

According to example embodiments of the present disclosure, because data encryption operations may also be encryption executed by a legitimate user, therefore, to ensure that legitimate users may encrypt data as normal, and prevent illicit users from maliciously encrypting data, improving accuracy of preventing data encryption operations, notification may be made regarding the data encryption operation, and after receiving feedback information confirming that the data encryption operation includes an attack behavior, execution of the data encryption operation is evaluated.

Herein, a manner of notifying regarding data encryption operation may be the same as an aforementioned manner of notifying regarding a data operation behavior, and a manner of evaluating execution of data encryption may be the same as an aforementioned manner of evaluating a data operation behavior; these shall not be reiterated herein.

According to example embodiments of the present disclosure, first, a data operation behavior may be detected and whether the data operation includes a write operation determined, and when a write operation is determined as being a data encryption operation, based on a preset rule, execution of the data encryption operation is evaluated on a timely basis, effectively reducing the problem of data loss or damage to an electronic device that may result from malicious encryption, improving security and reliability of data and the electronic device.

Second, with regard to a data operation behavior including a write operation, data processing features of a data processing unit with regard to the write operation may be obtained. Because the data processing features may describe characteristics exhibited by a processing procedure or by processing results of a data processing unit during data processing based on the data operation behavior, therefore, based on the data processing features, the data operation behavior may be recognized, improving accuracy of recognizing data encryption operations.

Additionally, with regard to a data encryption operation already confirmed by recognition, a user may be notified regarding the data encryption operation, and upon receiving feedback information confirmed by the user, the data encryption operation is evaluated, ensuring that legitimate users may encrypt data as normal, and illicit users are prevented from maliciously encrypting data on a timely basis, improving accuracy of preventing data encryption operations.

Persons skilled in the art will appreciate that method steps of the above-mentioned example embodiments are not each essential, and under particular circumstances, one or more steps therein may be omitted, as long as the technical objectives of performing recognition or data processing upon an electronic device are realized. The present disclosure is not limited to the number and order of steps of the example embodiments, and the scope of protection of the present disclosure shall be subject to the features of the claims.

To facilitate persons skilled in the art to better understand the present disclosure, a data processing method according to example embodiments of the present disclosure is described below through a particular example, particularly including the below steps:

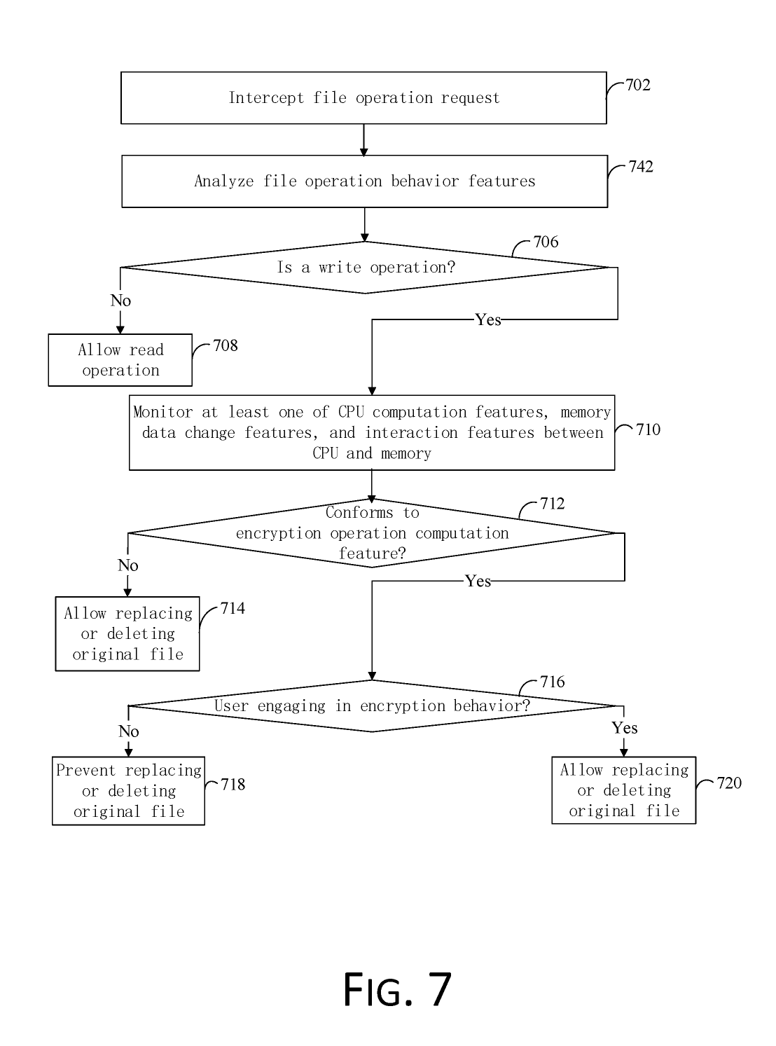

Referring to FIG. 7, a flowchart of a data processing method 700 is provided. The method includes:

Step 702, intercepting a file operation request;

Herein, a file operation request is a request to execute a file operation, where file operation behaviors may include aforementioned data operation behaviors.

Step 704, analyzing file operation behavior features;

Operation features are behavior features possessed by file operations. By analyzing computer instructions or code included by a file operation behavior, thereby file operation behavior features may be determined.

Step 706, evaluating whether a file operation is a write operation based on the operation features, executing step 710 if so, and executing step 708 otherwise;

Step 708, allowing a read operation;

If the file operation is not a write operation, then the file operation is a read operation. A read operation will not result in changes to data in a file, so the read operation may be allowed.

Step 710: monitoring at least one of CPU computation features, memory data change features, and interaction features between a CPU and memory;

According to example embodiments of the present disclosure, memory may include a cache.

Through hardware or software having access permissions to the CPU and memory on an electronic device, the above-mentioned features may be monitored. For example, through an aforementioned monitoring unit or data operation monitoring component set up in an operating system kernel, the above-mentioned features may be monitored.

Step 712, recognizing, based on the monitored feature, whether the file operation conforms to an encryption operation computation feature, executing step 716 if so, and executing step 714 otherwise;

Because an encryption operation may be an attack behavior, and therefore a file operation including an encryption operation, compared to a file operation not including an encryption operation, will occupy more resources and have different computation features, such as occupying more CPUs, causing higher CPU frequencies, obtaining more data from internal memory and such memories, obtaining data from different storage locations and non-designated locations of memory, having more interactions with memory, and the like. Therefore, based on whether the monitored features conform to encryption operation computation features, whether a file operation is an encryption operation may be determined. For example, when interaction features between a CPU and internal memory confirm to computation features of some encryption algorithm, a magnitude of information entropy change between data before and after the file operation conforms to a magnitude of information entropy change before and after encryption, and a CPU clock speed and occupation conform to a CPU clock speed and occupation while an encryption operation is included, then the monitored file operation may be determined as an encryption operation.

Step 714, allowing replacing or deleting an original file;

If the current file operation is not an encryption operation, then the file operation may be determined as safe, and the file operation may be allowed to replace or delete an original file.

Step 716, notifying a user to confirm whether they are engaging in encryption behavior, executing step 720 if so, and executing step 718 if not;

If the current file operation is an encryption operation, then the encryption operation may also be encryption of a file by a legitimate user. So, to improve reliability of data processing, a user may be notified to confirm the encryption behavior.

Step 718, preventing replacing or deleting the original file;

With regard to encryption not by a legitimate user, the encryption operation is not trustworthy, and replacing or deleting an original file may be prevented, reducing the likelihood of the problems of creating data loss or other harm to electronic device security.

Step 720, allowing replacing or deleting the original file.

With regard to a trustworthy encryption operation, replacing or deleting the original file may be allowed.

### Fifth Example Embodiment

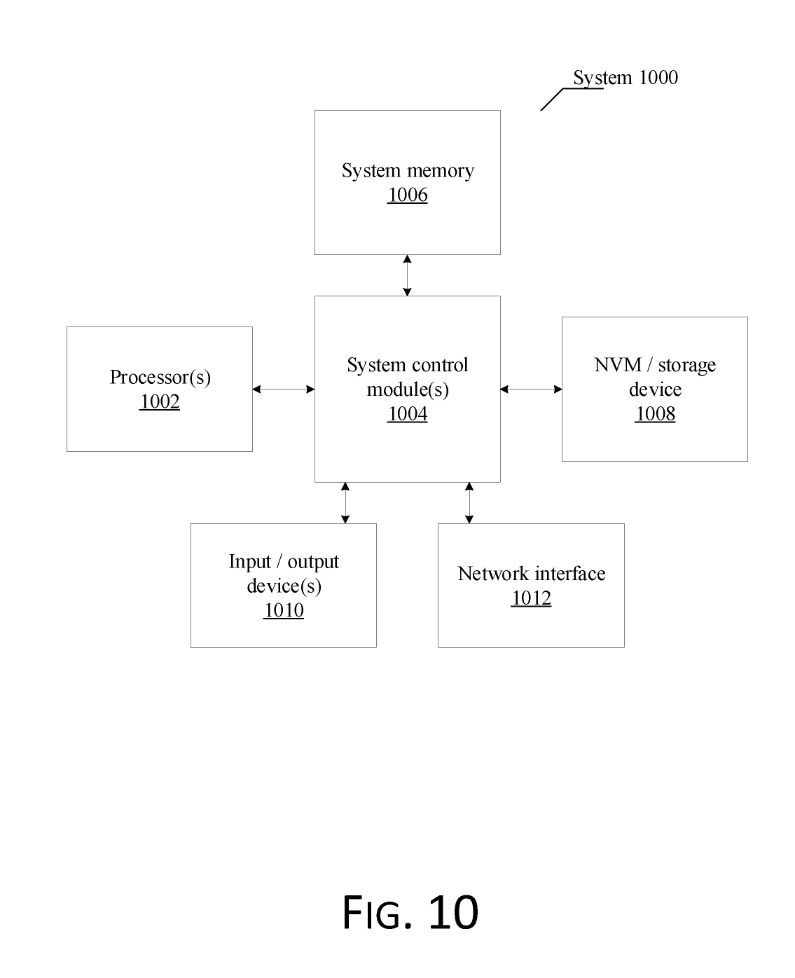

Referring to FIGS. 8A and 8B, structural diagrams of a behavior recognition apparatus 800 according to an example embodiment of the present disclosure are illustrated, the behavior recognition apparatus 800 being implemented on a system 1000 of FIG. 10 including one or more processor(s) 1002, at least one system control module(s) (chipset(s)) 1004, system memory 1006, non-volatile memory (NVM)/a storage device 1008, one or more input/output devices 1010, and a network interface 1012 as described below. Memory 802 of the behavior recognition apparatus 800 may be one or more of the system memory 1006 and the non-volatile memory/storage device 1008 and is operative to store program instructions and/or data. The behavior recognition apparatus 800 further includes:

A data operation behavior detecting module 804 stored in the memory 802 and configured to be executable by the one or more processor(s) 1002 to cause the one or more processor(s) 1002 to detect a data operation behavior;

A data processing feature obtaining module 806 stored in the memory 802 and configured to be executable by the one or more processor(s) 1002 to cause the one or more processor(s) 1002 to obtain data processing features of a data processing unit with regard to the data operation behavior; and

A data operation behavior recognizing module 808 stored in the memory 802 and configured to be executable by the one or more processor(s) 1002 to cause the one or more processor(s) 1002 to recognize the data operation behavior based on the data processing features.

The data processing feature obtaining module 806 may include:

A processing attribute information obtaining submodule 810 stored in the memory 802 and configured to be executable by the one or more processor(s) 1002 to cause the one or more processor(s) 1002 to obtain processing attribute information of the data processing unit; and

A data processing feature determining submodule 812 stored in the memory 802 and configured to be executable by the one or more processor(s) 1002 to cause the one or more processor(s) 1002 to determine change data of processing attribute information before and after data processing, designated as data processing features of the data processing behavior.

The processing attribute information may include at least one of data attribute information, interaction status information between processing units, unit execution status information, and unit attribute information.

The data processing features may include at least one of data change information, interaction change information, execution status change information, and unit attribute change information of processing units.

The data processing feature obtaining module 806 may include:

A data processing unit determining submodule 814 stored in the memory 802 and configured to be executable by the one or more processor(s) 1002 to cause the one or more processor(s) 1002 to determine at least one data processing unit involved in a data processing procedure; and

A data processing unit monitoring submodule 816 stored in the memory 802 and configured to be executable by the one or more processor(s) 1002 to cause the one or more processor(s) 1002 to monitor data processing features of the at least one data processing unit.

The data processing unit may include external memory, internal memory, a cache or a processor.

The data operation behavior recognizing module 808 may include:

A first data operation behavior determining submodule 818 stored in the memory 802 and configured to be executable by the one or more processor(s) 1002 to cause the one or more processor(s) 1002 to determine the data operation behavior as conforming to a behavior type corresponding to an attack behavior.

The first data operation behavior determining submodule 818 may be further configured to:

Determine the data operation behavior as including a data write operation.

The data operation behavior recognizing module 808 may include:

A second data operation behavior determining submodule 820 stored in the memory 802 and configured to be executable by the one or more processor(s) 1002 to cause the one or more processor(s) 1002 to determine, based on the data processing features satisfying data processing features corresponding to data encryption operations, the data operation behavior as including a data encryption operation.

The data operation behavior recognizing module 808 may include:

A third data operation behavior determining submodule 822 stored in the memory 802 and configured to be executable by the one or more processor(s) 1002 to cause the one or more processor(s) 1002 to determine, based on the data processing features satisfying target data processing features corresponding to a feature operation behavior, the data operation behavior as including the feature operation behavior.

The apparatus 800 may further include:

A target data processing feature obtaining module 824 stored in the memory 802 and configured to be executable by the one or more processor(s) 1002 to cause the one or more processor(s) 1002 to obtain the target data processing features in at least one manner among statistical analysis, machine learning, and behavior pattern analysis.

The feature operation behavior may be an attack behavior, and the apparatus 800 may further include:

A blocking module 826 stored in the memory 802 and configured to be executable by the one or more processor(s) 1002 to cause the one or more processor(s) 1002 to block, if the data operation behavior is determined as including the feature operation behavior, execution of the data operation behavior.

The apparatus 800 may further include:

A notifying module 828 stored in the memory 802 and configured to be executable by the one or more processor(s) 1002 to cause the one or more processor(s) 1002 to notify regarding the feature operation behavior, and receive feedback information confirming that the feature operation behavior includes an attack behavior.

The data processing feature obtaining module 806 may include:

A data processing feature obtaining submodule 830 stored in the memory 802 and configured to be executable by the one or more processor(s) 1002 to cause the one or more processor(s) 1002 to through a monitoring unit of an operating system kernel, obtain the data processing features, the monitoring unit having monitoring authorization with regard to the data processing unit.

The data operation behavior detecting module 808 may include:

A data operation behavior detecting submodule 832 stored in the memory 802 and configured to be executable by the one or more processor(s) 1002 to cause the one or more processor(s) 1002 to detect a data operation behavior of an external device.

The apparatus 800 further may include:

A user registration request receiving module 834 stored in the memory 802 and configured to be executable by the one or more processor(s) 1002 to cause the one or more processor(s) 1002 to receive a user registration request of the external device, and complete a user registration flow of the external device based on a public key and a certificate of each of the current device and the external device.

The public key and private key of the current device may be saved on a built-in trusted chip.

The apparatus 800 may further include:

A certificate obtaining module 836 stored in the memory 802 and configured to be executable by the one or more processor(s) 1002 to cause the one or more processor(s) 1002 to obtain public keys and certificates of each of the external device and the current device from a platform certification authority, utilized to complete a user registration flow of the external device.

An embodiment of the present application further discloses a computer readable storage medium, wherein the computer readable storage medium stores instructions which, when running on a computer, enable the computer to perform the processes described above. The memory 802 is an example of a computer readable medium.

In implementations, the memory 802 may include program modules 890 and program data 892. The program modules 892 may include one or more of the modules as described above.

According to example embodiments of the present disclosure, data operation behaviors may be detected, and data processing features of a data processing unit with regard to data operation behaviors obtained. Because the data processing features may describe a processing procedure of the data processing unit or characteristics exhibited by processing results while processing data based on the data operation behaviors, therefore based on the data processing features, data operation behaviors in accordance may be recognized, which is beneficial to performing governance upon the various data operation behaviors of an electronic device, preventing or blocking potentially hazardous data operation behaviors, exercising preventative measures, effectively reducing the likelihood of data loss on the electronic device or damage to the electronic device, and increasing security and reliability of data and the electronic device.

### Sixth Example Embodiment

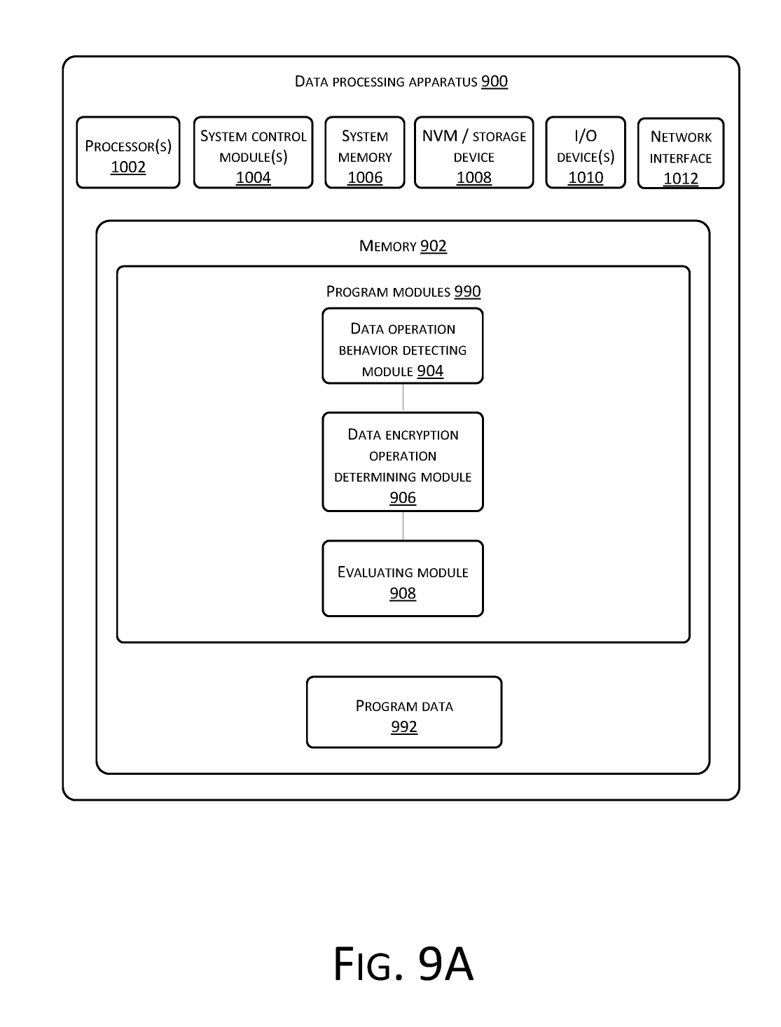

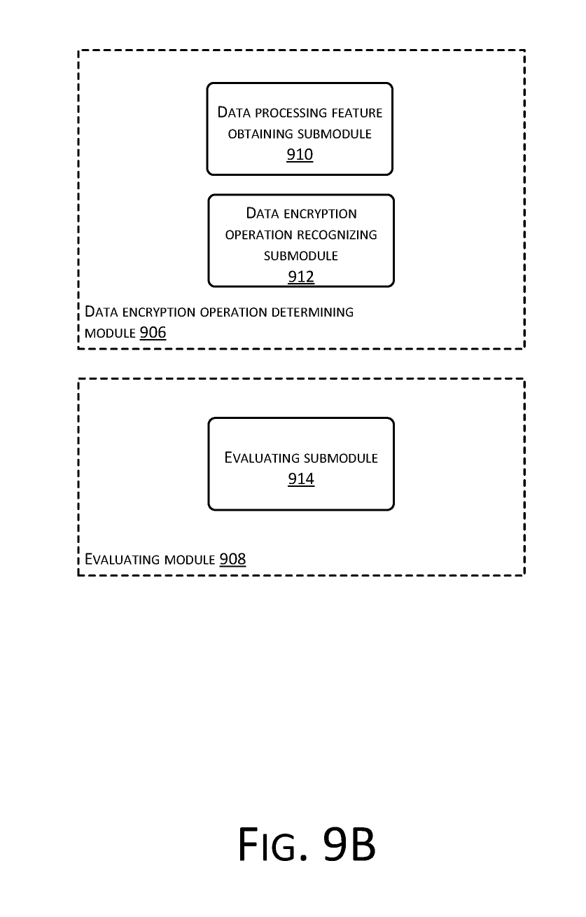

Referring to FIGS. 9A and 9B, structural diagrams of a data processing apparatus 900 according to an example embodiment of the present disclosure are illustrated, being implemented on a system 1000 of FIG. 10 including one or more processor(s) 1002, at least one system control module(s) (chipset(s)) 1004, system memory 1006, non-volatile memory (NVM)/a storage device 1008, one or more input/output devices 1010, and a network interface 1012 as described below. Memory 902 of the behavior recognition apparatus 900 may be one or more of the system memory 1006 and the non-volatile memory/storage device 1008 and is operative to store program instructions and/or data. The data processing apparatus 900 further includes:

A data operation behavior detecting module 904 stored in the memory 902 and configured to be executable by the one or more processor(s) 1002 to cause the one or more processor(s) 1002 to detect a data operation behavior, and determine that the data operation behavior includes a write operation;

A data encryption operation determining module 906 stored in the memory 902 and configured to be executable by the one or more processor(s) 1002 to cause the one or more processor(s) 1002 to determine that the write operation is a data encryption operation; and

An evaluating module 908 stored in the memory 902 and configured to be executable by the one or more processor(s) 1002 to cause the one or more processor(s) 1002 to evaluate, based on a preset rule, execution of the data encryption operation.

The data encryption operation determining module 906 may include:

A data processing feature obtaining submodule 910 stored in the memory 902 and configured to be executable by the one or more processor(s) 1002 to cause the one or more processor(s) 1002 to obtain data processing features of a data processing unit with regard to the write operation; and

A data encryption operation recognizing submodule 912 stored in the memory 902 and configured to be executable by the one or more processor(s) 1002 to cause the one or more processor(s) 1002 to recognize, based on the data processing features, the write operation as a data encryption operation.

The evaluating module 908 may include:

An evaluating submodule 914 stored in the memory 902 and configured to be executable by the one or more processor(s) 1002 to cause the one or more processor(s) 1002 to notify regarding the data encryption operation, and after receiving feedback information confirming that the data encryption operation includes an attack behavior, block execution of the data encryption operation.

An embodiment of the present application further discloses a computer readable storage medium, wherein the computer readable storage medium stores instructions which, when running on a computer, enable the computer to perform the processes described above. The memory 902 is an example of a computer readable medium.

In implementations, the memory 902 may include program modules 990 and program data 992. The program modules 992 may include one or more of the modules as described above.

According to example embodiments of the present disclosure, a data operation behavior may be detected and whether the data operation includes a write operation determined, and when a write operation is determined as being a data encryption operation, based on a preset rule, execution of the data encryption operation is evaluated on a timely basis, effectively reducing the problem of data loss or damage to an electronic device that may result from malicious encryption, improving security and reliability of data and the electronic device.

Memory of the above-mentioned example embodiments is an example of a computer readable medium. The computer readable medium may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media do not include transitory media, such as modulated data signals and carrier waves.

With regard to example embodiments of apparatuses, because they are essentially similar to example embodiments of methods, they are described comparatively simply, and referring to related example embodiments of methods shall suffice for description.

Example embodiments of the present disclosure may be implemented as a system configured as desired employing any suitable hardware, firmware, software, as well as any combination thereof. FIG. 10 schematically illustrates an exemplary system (or apparatus) 1000 which may be utilized to implement each example embodiment of the present disclosure.

With regard to an example embodiment, FIG. 10 illustrates an exemplary system 1000, the system having one or more processor(s) 1002, coupled to at least one system control module(s) (chipset(s)) 1204 of the (one or more) processor(s) 1002, coupled to system memory 1006 of the system control module(s) 1004, coupled to non-volatile memory (NVM)/a storage device 1008 of the system control module(s) 1004, coupled to one or more input/output devices 1010 of the system control module(s) 1004, and being coupled to a network interface 1012 of the system control module(s) 1004.

The processor(s) 1002 may include one or more single-core or multicore processors. The processor(s) 1002 may include any given combinations of general purpose processors or dedicated processors (such as graphics processors, application processors, baseband processors and the like). According to some example embodiments, the system 1000 may serve as an electronic device according to example embodiments of the present disclosure.

According to some example embodiments, the system 1000 may include one or more computer-readable media (such as the system memory 1006 or the NVM/storage device 1008) having instructions thereon, the one or more processor(s) 1002 being configured to, in conjunction with the one or more computer-readable media, execute instructions to implement modules which execute acts according to the present disclosure.

With regard to an example embodiment, the system control module(s) 1004 may include any suitable interface controller, to provide any suitable interfaces for at least one of the one or more processor(s) 1002 and/or for any suitable devices or combinations which the system control module(s) 1004 are in communication with.

The system control module(s) 1004 may include a memory controller module, providing an interface for the system memory 1006. The memory controller module may be a hardware module, software module and/or firmware module.

The system memory 1006 may be utilized to, for example, load and/or store data and/or instructions for the system 1000. According to an example embodiment, the system memory 1006 may include any suitable volatile memory, for example, suitable DRAM. According to some example embodiments, the system memory 1006 may include double data rate fourth-generation synchronous dynamic random-access memory (DDR4 SDRAM).

According to an example embodiment, the system controller module(s) 1004 may include one or more input/output controller, providing interfaces for the NVM/storage device 1008 and one or more input/output device(s) 1010.

For example, the NVM/storage device 1008 may be utilized to store data and/or instructions. The NVM/storage device 1008 may include any suitable non-volatile memory (for example, flash memory) and/or may include any suitable one or more non-volatile storage device(s) (for example, one or more hard disk drive(s) (HDD), one or more compact disc (CD) drive(s) and/or one or more digital versatile disc(s) (DVD)).

The NVM/storage device 1008 may include part of the storage resources of devices physically installed on the system 1000, or may be accessed by the devices and not necessarily being part of those devices. For example, the NVM/storage device 1008 may be accessed through a network via one or more input/output device(s) 1010.

One or more input/output device(s) 1010 may provide interfaces and any other suitable device communication for the system 1000. The input/output device(s) 1010 may include communication components, audio components, sensor components, and the like. The network interface 1012 may provide interfaces for the system 1000 to communicate through one or more network(s), and the system may, based on any standards and/or protocols among one or more wireless network standard(s) and/or protocol(s) to conduct wireless communication with one or more component(s) of a wireless network; for example, accessing a wireless network based on communication standards such as Wi-Fi, 2G or 3G, or combinations thereof to conduct wireless communication.

With regard to an example embodiment, the logic of one or more controller(s) (for example, a memory controller module) of the at least one system controller module(s) 1004 of the one or more processor(s) 1002 is packaged together. With regard to an example embodiment, the logic of one or more controller(s) of the at least one system controller module(s) 1004 of the one or more processor(s) 1002 packaged together forms a System-in-Package (SiP). With regard to an example embodiment, the logic of one or more controller(s) of the at least one system controller module(s) 1004 of the one or more processor(s) 1002 is integrated onto the same mold. With regard to an example embodiment, the logic of one or more controller(s) of the at least one system controller module(s) 1004 of the one or more processor(s) 1002 integrated onto the same mold forms a System on Chip (SoC).

According to various example embodiments, the system 1000 may be, but is not limited to: a workstation, a desktop computing device or a mobile computing device (for example, a laptop computing device, a handheld computing device, a tablet computer, a Netbook and the like). According to various example embodiments, the system 1000 may have more or fewer components and/or different architectures. For example, according to some example embodiments, the system 1000 includes one or more cameras, keyboards, liquid crystal display monitor (LCD) screens (including touchscreen displays), non-volatile memory ports, multiple antennas, graphics chips, application-specific integrated circuits (ASIC), and speakers.

Herein, if a monitor includes a touch panel, the monitor may be implemented as a touchscreen display, to receive input signals from users. A touch panel includes one or more touch-sensitive sensors which sense touch, sliding and gestures upon the touch panel. The touch-sensitive sensors may not merely sense the boundaries of touch or sliding motions, but also detect continuous times and pressure related to the touch or sliding operations.

Example embodiments of the present disclosure further provide a non-volatile computer-readable storage medium, the storage medium having stored thereon one or more modules (programs), where the one or more modules applied to a terminal device may cause the terminal device to execute instructions of method steps according to example embodiments of the present disclosure.

An example provides an apparatus, including: one or more processor(s); and, one or more machine-readable medium(s) having instructions stored thereon, which, when executed by the one or more processor(s), cause the apparatus to execute methods executed by an electronic device according to example embodiments of the present disclosure.

An example provides one or more machine-readable medium(s) having stored thereon instructions which, when executed by one or more processor(s), cause the apparatus to execute methods executed by an electronic device according to example embodiments of the present disclosure.

Example embodiments of the present disclosure disclose a behavior recognition, data processing method and apparatus.

Example 1, a behavior recognition method, including:

detecting a data operation behavior;

obtaining data processing features of a data processing unit with regard to the data operation behavior; and

recognizing the data operation behavior based on the data processing features.

Example 2 may include the method of example 1, wherein obtaining data processing features of a data processing unit with regard to the data operation behavior includes:

obtaining processing attribute information of the data processing unit; and

determining change data of processing attribute information before and after data processing, designated as data processing features of the data processing behavior.

Example 3 may include the method of example 2, wherein the processing attribute information includes at least one of data attribute information, interaction status information between processing units, unit execution status information, and unit attribute information.

Example 4 may include the method of example 1, wherein the data processing features include at least one of data change information, interaction change information, execution status change information, and unit attribute change information of processing units.

Example 5 may include the method of example 1, wherein obtaining data processing features of a data processing unit with regard to the data operation behavior includes:

determining at least one data processing unit involved in a data processing procedure; and

monitoring data processing features of the at least one data processing unit.

Example 6 may include the method of example 1, wherein the data processing unit includes external memory, internal memory, a cache or a processor.

Example 7 may include the method of example 1, wherein recognizing the data operation behavior based on the data processing features includes:

determining the data operation behavior as conforming to a behavior type corresponding to an attack behavior.

Example 8 may include the method of example 7, wherein determining the data operation behavior as conforming to a behavior type corresponding to an attack behavior includes:

determining the data operation behavior as including a data write operation.

Example 9 may include the method of example 8, wherein recognizing the data operation behavior based on the data processing features includes:

determining, based on the data processing features satisfying data processing features corresponding to data encryption operations, the data operation behavior as including a data encryption operation.

Example 10 may include the method of example 1, wherein recognizing the data operation behavior based on the data processing features includes:

determining, based on the data processing features satisfying target data processing features corresponding to a feature operation behavior, the data operation behavior as including the feature operation behavior.

Example 11 may include the method of example 10, wherein the method further includes:

obtaining the target data processing features in at least one manner among statistical analysis, machine learning, and behavior pattern analysis.

Example 12 may include the method of example 10, wherein the feature operation behavior is an attack behavior, and the method further includes:

blocking, if the data operation behavior is determined as including the feature operation behavior, execution of the data operation behavior.

Example 13 may include the method of example 12, wherein before blocking execution of the data operation behavior, the method further includes:

notifying regarding the feature operation behavior, and receiving feedback information confirming that the feature operation behavior includes an attack behavior.

Example 14 may include the method of example 1, wherein obtaining data processing features of a data processing unit with regard to the data operation behavior includes:

obtaining, through a monitoring unit of an operating system kernel, the data processing features, the monitoring unit having monitoring authorization with regard to the data processing unit.

Example 15 may include the method of example 1, wherein detecting the data operation behavior further includes:

detecting a data operation behavior of an external device.

Example 16 may include the method of example 15, wherein before detecting the data operation behavior, the method further includes:

receiving a user registration request of the external device, and completing a user registration flow of the external device based on a public key and a certificate of each of the current device and the external device.

Example 17 may include the method of example 16, wherein the public key and private key of the current device are saved on a built-in trusted chip.

Example 18 may include the method of example 15, the method further including:

obtaining public keys and certificates of each of the external device and the current device from a platform certification authority, utilized to complete a user registration flow of the external device.

Example 19, a data processing method, including:

detecting a data operation behavior, and determining that the data operation behavior includes a write operation;

determining that the write operation is a data encryption operation; and evaluating, based on a preset rule, execution of the data encryption operation.

Example 20 may include the method of example 19, wherein determining that the write operation is a data encryption operation includes:

obtaining data processing features of a data processing unit with regard to the write operation; and

recognizing, based on the data processing features, the write operation as a data encryption operation.

Example 21 may include the method of example 19, wherein evaluating, based on a preset rule, execution of the data encryption operation includes:

notifying regarding the data encryption operation, and after receiving feedback information confirming that the data encryption operation includes an attack behavior, evaluating execution of the data encryption operation.

Example 22, a behavior recognition apparatus, including:

a data operation behavior detecting module, configured to detect a data operation behavior;

a data processing feature obtaining module, configured to obtain data processing features of a data processing unit with regard to the data operation behavior; and

a data operation behavior recognizing module, configured to recognize the data operation behavior based on the data processing features.

Example 23, a data processing apparatus, including:

a data operation behavior detecting module, configured to detect a data operation behavior, and determine that the data operation behavior includes a write operation;

a data encryption operation determining module, configured to determine that the write operation is a data encryption operation; and

an evaluating module, configured to, based on a preset rule, evaluate execution of the data encryption operation.

Example 24, an apparatus, including: one or more processors; and one or more machine-readable media having stored thereon instructions which, upon executed by the one or more processors, cause the apparatus to execute one or more methods of the examples 1-21.

Example 25, one or more computer-readable storage media, having stored thereon instructions which, upon being executed by one or more processors, cause an apparatus to execute one or more methods of the examples 1-21.

Although certain example embodiments herein have the objective of providing explanation and description, various alternatives and/or equivalent implementations or implementations which arrive at the same objectives by computation as illustrated and described by the example embodiments shall not be removed from the scope of implementation of the present disclosure. The present disclosure is intended to cover any modifications or changes to the example embodiments discussed in the present text. Therefore, it is clear that example embodiments described by the present text delineate the claims as well as their equivalents.

What is claimed is:

1. A behavior recognition method, comprising:
detecting a data operation behavior;
obtaining data processing features of a data processing unit with regard to the data operation behavior; and
recognizing the data operation behavior based on the data processing features.

2. The method of claim 1, wherein obtaining data processing features of a data processing unit with regard to the data operation behavior comprises:
obtaining processing attribute information of the data processing unit; and
determining change data of processing attribute information before and after data processing, designated as data processing features of the data processing behavior.

3. The method of claim 2, wherein the processing attribute information comprises at least one of data attribute information, interaction status information between processing units, unit execution status information, and unit attribute information.

4. The method of claim 1, wherein the data processing features comprise at least one of data change information, interaction change information, execution status change information, and unit attribute change information of processing units.

5. The method of claim 1, wherein obtaining data processing features of a data processing unit with regard to the data operation behavior comprises:
determining at least one data processing unit involved in a data processing procedure; and
monitoring data processing features of the at least one data processing unit.

6. The method of claim 1, wherein the data processing unit comprises external memory, internal memory, a cache or a processor.

7. The method of claim 1, wherein recognizing the data operation behavior based on the data processing features comprises:
determining the data operation behavior as conforming to a behavior type corresponding to an attack behavior.

8. The method of claim 7, wherein determining the data operation behavior as conforming to a behavior type corresponding to an attack behavior comprises:
determining the data operation behavior as including a data write operation.

9. The method of claim 8, wherein recognizing the data operation behavior based on the data processing features comprises:
determining, based on the data processing features satisfying data processing features corresponding to data encryption operations, the data operation behavior as including a data encryption operation.

10. The method of claim 1, wherein recognizing the data operation behavior based on the data processing features comprises:
determining, based on the data processing features satisfying target data processing features corresponding to a feature operation behavior, the data operation behavior as including the feature operation behavior.

11. The method of claim 10, further comprising:
obtaining the target data processing features in at least one manner among statistical analysis, machine learning, and behavior pattern analysis.

12. The method of claim 10, wherein the feature operation behavior is an attack behavior, and further comprising:
blocking, if the data operation behavior is determined as including the feature operation behavior, execution of the data operation behavior.

13. The method of claim 12, further comprising before blocking execution of the data operation behavior:
notifying regarding the feature operation behavior, and receiving feedback information confirming that the feature operation behavior includes an attack behavior.

14. The method of claim 1, wherein obtaining data processing features of a data processing unit with regard to the data operation behavior comprises:
obtaining, through a monitoring unit of an operating system kernel, the data processing features, the monitoring unit having monitoring authorization with regard to the data processing unit.

15. The method of claim 1, wherein detecting the data operation behavior further comprises:
detecting a data operation behavior of an external device.

16. The method of claim 15, further comprising before detecting the data operation behavior:
receiving a user registration request of the external device, and completing a user registration flow of the external device based on a public key and a certificate of each of the current device and the external device.

17. The method of claim 16, wherein the public key and private key of the current device are saved on a built-in trusted chip.

18. The method of claim 15, the method further comprising:
obtaining public keys and certificates of each of the external device and the current device from a platform certification authority, utilized to complete a user registration flow of the external device.

19. A data processing method, comprising:
detecting a data operation behavior, and determining that the data operation behavior includes a write operation;
determining that the write operation is a data encryption operation; and
evaluating, based on a preset rule, execution of the data encryption operation.

20. A behavior recognition apparatus, comprising:
a data operation behavior detecting module, configured to detect a data operation behavior;
a data processing feature obtaining module, configured to obtain data processing features of a data processing unit with regard to the data operation behavior; and
a data operation behavior recognizing module, configured to recognize the data operation behavior based on the data processing features.
